(19) United States
(12) Patent Application Publication
(10) Pub. No.: US 2015/0213267 A1
(43) Pub. Date: Jul. 30, 2015

(54) REMOTE ENTERPRISE SECURITY COMPLIANCE REPORTING TOOL

(71) Applicant: SMARTRONIX, INC., Hollywood, MD (US)

(72) Inventors: Keith NANCE, Hilo, HI (US); William MORROW, San Antonio, TX (US); Michael SHELDON, Poway, CA (US); Eric WALTERS, Overland Park, KS (US); Jeffrey WATTS, Spotsylvania, VA (US)

(21) Appl. No.: 14/318,855

(22) Filed: Jun. 30, 2014

Related U.S. Application Data
(60) Provisional application No. 61/931,786, filed on Jan. 27, 2014.

(51) Int. Cl. G06F 21/57

(52) U.S. Cl. CPC G06F 21/57

(57) ABSTRACT

Described is a method for cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration. Also described are an apparatus and a machine-readable medium for performing this method.

### CROSS-REFERENCE TO RELATED APPLICATIONS

This application claims benefit of priority to U.S. Provisional Patent Application No. 61/931,786 filed Jan. 27, 2014 which is incorporated by reference in its entirety.

### BACKGROUND

1. Field of the Invention

The present invention relates compliance checks on networking

2. Background of the Invention

Compliance checks on most information technology (IT) related devices are manually intensive. Regardless of the methods utilized, in order to fully identify the status of a network device, multiple layers of contextual data must be referenced. At present, there are no systems currently available that provides this in-depth contextual awareness.

### SUMMARY

According to a first broad aspect, the present invention provides a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium.

According to a second broad aspect, the present invention provides apparatus comprising: one more processors, and one or more machine-readable media for storing instructions thereon which when executed by the one or more processors cause the one or more processors to perform a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium.

According to a third broad aspect, the present invention provides a machine-readable medium having stored thereon sequences of instructions that when executed by one or more processors cause the one or more processors to perform a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium.

According to a fourth broad aspect, the present invention provides a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium, wherein the one or more defined entities comprise one or more defined internal entities.

According to a fifth broad aspect, the present invention provides apparatus comprising: one more processors, and one or more machine-readable media for storing instructions thereon which when executed by the one or more processors cause the one or more processors to perform a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium, wherein the one or more defined entities comprise one or more defined internal entities.

According to a sixth broad aspect, the present invention provides a machine-readable medium having stored thereon sequences of instructions that when executed by one or more processors cause the one or more processors to perform a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium, wherein the one or more defined entities comprise one or more defined internal entities.

According to a seventh broad aspect, the present invention provides a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium, wherein the one or more defined entities comprise one or more defined external entities.

According to an eighth broad aspect, the present invention provides apparatus comprising: one more processors, and one or more machine-readable media for storing instructions thereon which when executed by the one or more processors cause the one or more processors to perform a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium, wherein the one or more defined entities comprise one or more defined external entities.

According to a ninth broad aspect, the present invention provides a machine-readable medium having stored thereon sequences of instructions that when executed by one or more processors cause the one or more processors to perform a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium, wherein the one or more defined entities comprise one or more defined external entities.

According to a tenth broad aspect, the present invention provides a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium, wherein the one or more defined entities comprise one or more defined premise entities.

According to a eleventh broad aspect, the present invention provides apparatus comprising: one more processors, and one or more machine-readable media for storing instructions thereon which when executed by the one or more processors cause the one or more processors to perform a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium, wherein the one or more defined entities comprise one or more defined premise entities.

According to a twelfth broad aspect, the present invention provides a machine-readable medium having stored thereon sequences of instructions that when executed by one or more processors cause the one or more processors to perform a method comprising the following steps: (a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration; (b) producing results for the applicability, non-applicability, compliance and/or non-compliance of a policy, set of policies, and/or policy checks with respect to the system configuration, system component configuration and/or system IT asset configuration based on the cross-referencing of step (a); and (c) displaying the results of step (b) on a visual display device and/or saving the results of step (b) to a storage medium, wherein the one or more defined entities comprise one or more defined premise entities.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 is a diagram showing a compliance reporting tool according to one embodiment of the present invention.

FIG. 2 is a diagram showing the hierarchy of graphical user interfaces of a compliance reporting tool according to one embodiment of the present invention.

FIGS. 3 and 3-1 illustrate a Device Discovery Process Flow Diagram for a Discover Devices page according to one embodiment of the present invention.

FIGS. 4, 4-1 and 4-2 show a Test Plan Execution Process Flow Diagram for creating and conducting test plans according to one embodiment of the present invention.

FIG. 5 is a screenshot of a Login page according to one embodiment of the present invention.

FIG. 6 is a screenshot of a “Create Site” initiate page according to one embodiment of the present invention.

FIG. 7 is a screenshot of a home page for a compliance reporting tool according to one embodiment of the present invention.

FIG. 8 is a screenshot of a Site Info page for a Create a Site page for the compliance reporting tool of FIG. 7.

FIG. 9 is a screenshot of a Site Personnel page for the Create Site page of FIG. 8.

FIG. 10 is a screenshot of an Add Contact window for the Site Personnel page of FIG. 9.

FIG. 11 is a screenshot of a PPSM (Ports Protocols and Services Management) page for the Create Site page of FIG. 8.

FIG. 12 is a screenshot of an Add PPSM window for the PPSM page of FIG. 11.

FIG. 13 is a screenshot of the PPSM page of FIG. 11 after data has been entered.

FIG. 14 is a screenshot of an IP/Subnet Space page for the Create Site page of FIG. 8.

FIG. 15 is a screenshot of a Device Functional Location page for the Create Site page of FIG. 8.

FIG. 16 is a screenshot of an IPv4 and IPv6 page for the Create Site page of FIG. 8.

FIG. 17 is a screenshot of a Confirm for the Create Site page of FIG. 8.

FIG. 18 is a screenshot of a page with a Discover button that is displayed after a site is created using the Create Site page of FIG. 8.

FIG. 19 is a screenshot of an Edit Site Info page for the Create Site page of FIG. 8 with data having been previous entered on the Create Site page.

FIG. 20 is a screenshot of the window that appears when a Browse button on the Site Info page of FIG. 19 is selected.

FIG. 21 is a screenshot of a Discover Devices page linked to the home page of FIG. 7.

FIG. 22 is a screenshot of a pop-up Error window for the Discover Devices page of FIG. 21.

FIG. 23 is a screenshot of an All Devices page linked to the home page of FIG. 7.

FIG. 24 is a screenshot of a Device page for a device displayed on the All Devices page of FIG. 23.

FIG. 25 is a screenshot of an Edit page linked to the Device page of FIG. 24

FIG. 26 is a screenshot of a Create a New Test Plan page linked to the home page of FIG. 7.

FIG. 27 is a screenshot of a Test Plan page displayed on the Create a New Test Plan page of FIG. 26.

FIG. 28 is a screenshot of a device credential pop-up that is displayed to a user when an Execute Test button is selected on the Test Plan page of FIG. 27.

FIG. 29 is a screenshot of the Test Plan page of FIG. 27 as a series of Test Plan functions are being executed.

FIG. 30 is a screenshot a Devices in Test window for a Test Plan results page for the Test Plan Page of FIG. 27 after the Test Plan has been completed successfully.

FIG. 31 is a screenshot of a page displaying a listing of each STIG rule check and the results of an analysis for each device for Devices in Test window of FIG. 30 after the Test Plan has been completed successfully.

FIG. 32 is a screenshot of a Rules Definition page that is accessed by expanding an STIG rule link of the Devices in Test window of FIG. 31.

FIG. 33 is a screenshot of a Summary window of Test Plan results for the Test Plan results page of FIG. 30.

FIG. 34 is a screenshot of a Raw Results of Test Plan results for the Test Plan results page of FIG. 30.

FIG. 35 is a screenshot of a STIG page linked to the home page of FIG. 7 that includes a STIG viewer.

FIG. 36 is a screenshot of a STIG viewer of FIG. 35 being used to conduct a search with a filter.

FIG. 37 is a screenshot showing a window that is displayed by clicking on a document listed on a display of STIG viewer of FIG. 36.

FIG. 38 is a screenshot of rules linked to the STIG viewer of FIG. 35.

### DETAILED DESCRIPTION OF THE PREFERRED EMBODIMENTS

### Definitions

Where the definition of terms departs from the commonly used meaning of the term, applicant intends to utilize the definitions provided below, unless specifically indicated.

For purposes of the present invention, directional terms such as “top,” “bottom,” “upper,” “lower,” “above,” “below,” “left,” “right,” “horizontal,” “vertical,” “upward,” “downward,” etc., are merely used for convenience in describing the various embodiments of the present invention.

For purposes of the present invention, the term “accounts entity” refers to an entity that contains account-related objects that are associated with a system, system components, or system IT asset in order to provide compliance enumeration based upon the defined objects. Examples of describable objects may be a username, policy name, device IP or Hostnames or some other user defined description that supports the enumeration thereof.

For purposes of the present invention, the term “administrative authority” refers to the system administrator who is responsible for the configuration and managing the operation of a computer system, a server or a network of computers.

For purposes of the present invention, the term “applicability” with respect to a policy, set of policies and/or policy checks refers to the determining factor by which a policy, set of policies and/or policy check MUST be applied to a given system, system component, or system IT asset in order to enumerate the compliance or non-compliance status.

For purposes of the present invention, the term “associated object” refers to any conventional object that describes the system, system component, or system IT asset, such as Serial Number, MAC Address, Hostname, IP address, Account names, Policy document name, etc. The object must be relevant to the defined entity to which it is associated, as well as to the system, system component, or system IT asset(s).

For purposes of the present invention, the term “BOGON entity” refers to the defined entity in which well-known BOGON associated objects may be described. The BOGON associated objects may or may not be under the organization/system administrative authority. In one embodiment of the present invention, a BOGON entity may be used to define the list of un-registered, non-routable IP spaces as managed by Internet Registration Authorities.

For purposes of the present invention, the term “boundary,” the term “edge,” and the term “perimeter” refer to physical or logical perimeter of a zone, enclave, system or component of a system.

For purposes of the present invention, the term “boundary zone” and the term “perimeter zone” refer to a portion of an enclave that act as the bridging point between at least two defined zones, such as internal and external zones. A “boundary zone” is a portion of an enclave that has traditionally been labeled as perimeter, boundary, or gateway in a system. An example of a boundary zone is an internal perimeter zone that services at least two distinct types of internally defined zones. Another example of a boundary zone is an external perimeter zone that services at least two externally defined zones.

For purposes of the present invention, the term “checksums entity” refers to the defined entity in which well-known Application or Operating system associated checksum objects may be described. In one embodiment of the present invention, a Checksum entity may be used to define the list of Manufacture validated OS checksums in order to validate a system, system components, or system IT asset operational OS against the validated list.

For purposes of the present invention, the term “Community of Interest (COI) entity” refers to a defined entity or entities in which associated objects share a special or extenuating circumstance that do not conform to the common criteria as applied to the system, system components, or system IT asset. The associated objects for a COI entity are under the organization/system administrative authority. A COI entity provides a location to define UAIs that would extend further context awareness as needed.

For purposes of the present invention, the term “compliance” refers to conforming to a rule, such as a specification, policy, standard or law, etc. Certified and Accredited (C&A) Systems must go through a C&A process that involves the system as a whole or the individual components of the system which leads to compliance or various levels of compliance.

For purposes of the present invention, the term “computer” refers to any type of computer or other device that implements software including an individual computer such as a personal computer, laptop computer, tablet computer, mainframe computer, mini-computer, etc. A computer also refers to electronic devices such as an electronic scientific instrument such as a spectrometer, a smartphone, an eBook reader, a cell phone, a television, a handheld electronic game console, a videogame console, a compressed audio or video player such as an MP3 player, a Blu-ray player, a DVD player, etc. In addition, the term “computer” refers to any type of network of computers, such as a network of computers in a business, a computer bank, the Cloud, the Internet, etc. Various processes of the present invention may be carried out using a computer. Various functions of the present invention may be performed by one or more computers.

For purposes of the present invention, the term “computer system” refers to a system of interconnected computers.

For purposes of the present invention, the term “configuration” with respect to a system, system component or system IT asset refers to any form of an arrangement of elements in a particular form, figure, or combination that describes the operational order or status of a system, system component, or system IT asset.

For purposes of the present invention, the term “context” refers to the circumstances that form the setting for an event, statement, or idea, and in terms of which it can be fully understood and assessed. Context may be further defined as the descriptive assignment of a given name, identity, role, or function to any object or entity that describes an environment or system. The categorization of objects or entities within a system determines the relationship of the objects or entities to the system as a whole. For example, for an IP address for an IT asset, the IP address can be categorized as “Management” or “Non-Management” based on a procedure such as the following: (1) the context “Management IP subnets” is assigned to an entity and then (2) based on the context, a decision is made to add objects such as a list of IP addresses to the “Management IP subnets” entity. Using the above simple example, context awareness may now be possible in making a determination of the contextual status of a given devices IP address based upon its defined relationship to the system. Simply put, if the IP address is not defined within the “Management IP subnets” entity, it is not considered a Management IP address.

For purposes of the present invention, the term “contextual entity” refers to The defining of a specific entity in which it provides “context” to the system, system component, or system IT asset(s). An example would be to have an entity labeled as “IP Subnet” however that label does not provide context, whereas an entity labeled, “Management IP subnet” now provides context for the given system, system component, or system IT asset(s).

For purposes of the present invention, the term “cross-referencing” refers to comparing a defined entity or defined entities to something else. For example, in one embodiment of the present invention, programming logic may be used to cross-reference against a system, a system component and/or a system IT asset configuration to validate applicability, non-applicability and compliance and/or non-compliance of a policy, set of policies or policy checks.

For purposes of the present invention, the term “defining an entity” refers to the identification and labeling for reference of one or more of the following that are relevant, useful, and descriptive such as to provide context to the system as a whole: one or more elements of a system, one or more components of a system, one or more system components, and one or more system IT assets.

For purposes of the present invention, the term “demilitarized zone (DMZ)” refers to a physical or logical subnetwork that contains and exposes an organization's external-facing services to untrusted networks, such as the Internet.

For purposes of the present invention, the term “DMZ entity” refers to a defined entity that describes all DMZ associated objects as relevant to the system, system component, or system IT asset(s).

For purposes of the present invention, the term “enclave” refers to a collection of computing environments, or information systems connected by one or more internal networks under the control of a single authority and security policy, including personnel and physical security. The environment or information systems may be structured by physical proximity or by function, independent of location. An “enclave” are set of interacting or interdependent components that include a computer system and that form an integrated whole or a set of elements (called “components”) and relationships which are different from relationships of the set or its elements to other elements or sets. A typical “enclave” of the present invention is a computer system and various components that interact with one or more individual computers of the computer system or with the computer system as a whole. In some cases, the terms “enclave” and “system” may be synonymous. However, in some cases, the term “system” may just refer to a computer system exclusive of other components that may interact with the computer system.

For purposes of the present invention, the term “entity” and the term “defined entity” refer to an identified and labeled group of one or more of the following that are relevant, useful, and descriptive such as to provide context to the system as a whole: one or more elements of a system, one or more components of a system, one or more system components, and one or more system IT assets. An entity may contain a logical grouping of associated objects that help to describe and provide context to a system, system component or systems IT asset(s). An entity does not have to be populated with associated objects, i.e., may contain 0 objects, and therefore be an “empty entity.” However an entity may still provide relevance to the description of the system, system components, or system IT assets. For example, when describing a network, a premise entity may be left empty, or undefined if the network does not contain any premise-related objects.

For purposes of the present invention, the term “entity-related criteria” refers to the entities associated objects whereas each object that populates the entity must be relevant to that entity. Furthermore, it would be in-accurate and counter-intuitive to place an IP address object or MAC address object that is not management-related or has no relevance to the systems documented Management architecture. Examples of entity-related criteria for a system include: management-related criteria, internal-related criteria, external-related criteria, premise-related criteria, DMZ-related criteria, server-related criteria, accounts-related criteria, software-related criteria, policy-related criteria, network rules-related criteria, VLAN-related criteria, checksum-related criteria, BOGON-related criteria, etc. Objects may fit into one or more related criteria, once again, so long as that object is relevant to that entity.

For purposes of the present invention, the term “enumerate” refers to the identification of a list of items, such as in a policy or policy check and performing actions as specified within those items.

For purposes of the present invention, the term “external DMZ entity” refers to a defined entity that describes associated objects that conform to the systems, system components, or system IT asset(s) documented architecture described as External or Public and DMZ in relevance and function. The UAI for an external DMZ entity are under the organization/system administrative authority. In one embodiment of the present invention, External DMZ IP space or public DMZ IP spaces are technically external IPs that are specially designated for DMZ type purposes.

For purposes of the present invention, the term “external entity” and the term “public entity” refers to a defined entity that describes associated objects that conform to the systems, system components, or system IT asset(s) documented architecture described as external or public in relevance and function. The UAI in an external entity are under the organization/system administrative authority. In one embodiment of the present invention, an external entity may be used to identify UAIs that sit outside of designated internal entities but inside of the premise entities. In one embodiment of the present invention, an external entity may be used to define registered internet routable IPs and while restricted, are designated as publicly accessible.

For purposes of the present invention, the term “external zone” and the term “public zone” refer to an extranet. An external zone is a portion of an enclave that traditionally is labeled as external, outside, or public to a systems computing environment. The function of the external/public zone is to provide external/public services to the organization that may or may not also provide services to entities outside of the organization, such as the general public. The term “DMZ” or De-Militarized Zone generally sits within this category.

For purposes of the present invention, the term “function-specific servers entity” refers to a defined entity or entities that describes associated objects that conform to the systems, system components, or system IT asset(s) documented architecture described with the specified function. The UAI in a function-specific server's entity are under the organization/system administrative authority. One example of a function-specific server entity is a printer/print server's contextual entity. A printer/print server's entity contains UAI that are designated for printer-specific services and capabilities. Another of a function-specific server entity is a web server's contextual entity. A web server's contextual entity contains UAI that are designated for web-specific services and capabilities.

For purposes of the present invention, the term “hardware and/or software” refers to functions that may be performed by digital software, digital hardware, or a combination of both digital hardware and digital software. Various features of the present invention may be performed by hardware and/or software.

For purposes of the present invention, the term “in-band management entity” refers to a defined entity that describes associated objects that conform to the systems, system components, or system IT asset(s) documented architecture described as in-band management in relevance and function. The UAI in an in-band management entity are under the organization/system administrative authority. In one embodiment of the present invention, In-band management IP spaces are technically internal IPs that is specially designated for management purposes. The IP's also utilize the same physical architecture as the operational environment only being separated on a logical basis.

For purposes of the present invention, the term “internal zone” and the term “private zone” refers to an intranet. An internal zone is a portion of an enclave that traditionally is labeled as inside, internal, or private to the computing environment of a system. The function of an internal zone is to provide internal/private services to an organization that is usually restricted from general public access.

For purposes of the present invention, the term “internal DMZ entity” refers to a defined entity that describes associated objects that conform to the systems, system components, or system IT asset(s) documented architecture described as Internal or private and DMZ in relevance and function. The UAI for an internal DMZ entity are under the organization/system administrative authority. In one embodiment of the present invention, Internal DMZ IP spaces or private DMZ IP spaces are technically internal IPs that are specially designated for DMZ type purposes.

For purposes of the present invention, the term “internal entity” and the term “private entity” refer to a defined entity that describes associated objects that conform to the systems, system components, or system IT asset(s) documented architecture described as Internal or Private in relevance and function. The UAI in an internal entity are under are under the organization/system administrative authority. In one embodiment of the present invention, an internal entity may either be registered Internet routable IPs or RFC 1918 designated private IP spaces. If internal entities are registered internet routable IPs they are usually designated as internal if restricted access from external sources via perimeter security policies.

For purposes of the present invention, the term “IP” and the term “IP address” refers to an Internet Protocol address.

For purposes of the present invention, the term “IT asset” and the term “IT component” refers to any organizationally owned or controlled information, system or hardware that is used in the course of the organization's activities. For example, an IT asset may be: company-owned information, system(s) or hardware that is used in the course of business activities; government-controlled information, system(s) or hardware that is used in the course of governmental activities; etc.

For purposes of the present invention, the term “machine-readable medium” refers to any tangible or non-transitory medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” includes, but is limited to, solid-state memories, and optical and magnetic media. Specific examples of machine-readable media include non-volatile memory, including by way of example, semiconductor memory devices, e.g., EPROM, EEPROM, and flash memory devices; magnetic disks such as internal hard disks and removable disks; magneto-optical disks; and CD-ROM and DVD-ROM disks. The term “machine-readable medium” may include a single medium or multiple media (e.g., a centralized or distributed database, and/or associated caches and servers) that store the one or more instructions or data structures.

The term “management” refers to the monitoring and management of systems, system components, or system IT asset(s) of one or more enclaves by a system administrator. Unless specified otherwise, “management” refers to both in-band and out-of-band management. In computing, out-of-band management (sometimes called lights-out management (LOM) involves the use of a dedicated management channel for device maintenance. The terms “in-band management” and “out-of-band management” refer the actual physical channel, circuit, or medium that is used to access a device. In-band management uses a “shared” channel. Out-of-band management uses a “dedicated” channel.

For purposes of the present invention, the term “management entity” and the term “all management entity” refer to a defined entity and associated objects that are managed and monitored by a system administrator (sysadmin) A “management entity” describes associated objects that conform to the systems, system components, or system IT asset(s) documented architecture described as “Management” in relevance and function. The UAI in a management entity are under organization/system administrative authority. The UAIs in a management entity comprise of all management-related UAIs, both in-band and out-of-band as well as UAIs not listed in either in-band or out-of-band. In one embodiment of the present invention, Management IP spaces are technically Internal IPs that is specially designated for management purposes. Management IP spaces may use any channel necessary for management purposes.

For purposes of the present invention, the term “management zone” refers to the combination of an intranet and an extranet over which a system administrator exerts management authority. A management zone is a portion of an enclave that has traditionally been referred to as “administration,” “management,” “in-band management,” “out-of-band management,” or other synonymous term having relevance to administrative and authoritative activity. Not all zones in an enclave are management zones. For example, a zone that could be part of an enclave but not a management zone is an internal web zone that provides web services to internal users. Such an internal web zone would be part of an enclave would not allow standard administrative ports through, such as SSH, because SSH would be a part of the management zone of the enclave.

For purposes of the present invention, term the “microprocessor” refers to a computer processor contained on an integrated circuit chip, such a processor may also include memory and associated circuits. A microprocessor may further comprise programmed instructions to execute or control selected functions, computational methods, switching, etc. Various processes of the present invention may be carried out using a microprocessor.

For purposes of the present invention, the term “network” refers to a telecommunications network used to send and receive data. A “network” may be a computer network in which computers exchange data.

For purposes of the present invention, the term “network rules entity” refers to a defined entity that describes associated objects that conform to the systems, system components, or system IT asset(s) documented architecture described as “network 4ules,” “firewall rules,” “firewall policy,” “Access Control Lists (ACL's),” “route maps,” “policy maps,” “network policy,” or synonymous terms in relevance and function.

For purposes of the present invention, the term “object” refers to anything that contains or receives information. Examples of objects are IP address\Subnet\Network, VLAN, Serial Number, Hostnames, MAC address, account name, policy, documentation, or some user-defined object meeting a system's entity-related criteria.

For purposes of the present invention, the term “organization” refers to an entity of any size, complexity, or positioning within an organizational structure (e.g., a federal agency, or, as appropriate, any of the operational elements of a federal agency), including the entity comprising the entire organizational structure. An organization may be the entity with the highest level administrative authority over a given system.

For purposes of the present invention, the term “organization administrative authority” and “system administrative authority” refer to the ability of an organization or system (sometimes these terms are used interchangeably) to manage and maintain a given system, system component, or systems IT asset(s), acting within that organizations/systems complete autonomy. Administrative authority may sometimes be delegated to an organization/system from a higher level organization/system.

For purposes of the present invention, the term “organization container,” the term “system container” and the term “organization/system container” refer to the interchangeable names for defining an organization. In one embodiment of the present invention, an organization container or system container is a top level method of organizing the context structure for a compliance reporting tool and the users of a compliance reporting tool. and its users. For example, the United States Marine Corps (USMC) may be a top level organization/system container, a Marine Corps Base (MCB) could be another top level organization. etc. A single base or even a building may represent a “site” level structure.

For purposes of the present invention, the term “out-of-band management entity” refers to a defined entity that describes associated objects that conform to the systems, system components, or system IT asset(s) documented architecture described as out-of-band management in relevance and function. The UAI in an out-of-band management entity are under an organization/system administrative authority. An example of the use an out-of-band management entity is that the out-of-band management (OobM) IP spaces are technically Internal IPs that are specially designated for Management purposes. However, the IPs do not share the same physical architecture as the operational environment and utilize a separate designated OobM specific hardware for its management purposes.

For purposes of the present invention, the term “OS checksum white list entity” refers to an entity that defines the list of manufacturer validated OS checksums that are provided by the manufacturer to validate an applicable organization/system OS against. IN one embodiment of the present invention, an OS checksum white list entity may utilize the same hashing methods to create the validated checksums to create a checksum of operational or intended operational OS and comparing against that list for OS integrity.

For purposes of the present invention, the term “policy” refers to a course or principle of action adopted or proposed by a government, party, business, or individual. Policies may be further defined with functional labels such as “security”, “technical”, “non-technical”, “enterprise”, “local”, and “organizational”, or combination thereof, but not limited to these terms. In one embodiment of the present invention, there are no restrictions to the labeling of policies only that they are applicable to the objects or entities they are applied to. Along with government, party, business, or individuals; Policies may also be applied to individual IT Assets within a system, system components comprising multiple entities or IT assets, or the system as a whole. Policies may reference other objects that are not directly labeled as a “policy” but rather using the terms, “rules”, “requirements”, “guidance”, “standards”, “configuration”, “benchmarks”, “checks” or combination thereof. These objects in effect become policy driven; therefore, take on the functional role of policy. For example: The Department of Defense (DoD) utilizes a combination of technical and non-technical configuration guidance documents such as Security Technical Implementation Guide (STIG), Security Requirements Guide (SRG), and benchmarks that are applied against an IT Asset. By nature, a configuration guidance document may be utilized by any party, with or without a policy to configure an IT Asset. However, DoD policies DODD 8500.1 and DODI 8500.2 mandate the use of such configuration guides for adherence to policy compliance. Examples STIG checks mandated by a policy may include: (1) V-5611::SV-5611r2_rule and (2) V-17822::SV-19076r2_rule. In the V-5611::SV-5611r2_rule, management connections are not restricted. The network element must only allow management connections for administrative access from hosts residing in the management network. In the V-5611::SV-5611r2_rule, the management interface does not have an Access Control List (ACL). The network elements management interface must be configured with both an ingress and egress ACL.

For purposes of the present invention, the term “policy check” refers to a given set of instructions or guidance that must be acted upon due to policy enforcement.

For purpose of the present invention, the term “policy documents” refers to an entity that defines the list of user-provided validated policy documentation for a given system or site. The policies defined in a policy documents entity may or may not be under the organization/system administrative authority. In one embodiment of the present invention, a policy documents entity may provide a user with a location in which to search the organization/systems policy library for content and specific contextual requirements.

For purposes of the present invention, the term “policy entity” refers to a defined entity that describes associated objects that conform to the systems, system components, or system IT Asset(s) documented architecture and are associated with a given policy in relevance and function.

For purpose of the present invention, the term “policy exceptions entity” refers to an entity defines the list of user-provided validated policy exceptions for a given system or site. The policies defined in a policy exceptions entity may or may not be under the organization/system administrative authority. In embodiment of the present invention, a policy exceptions entity may provide an automated system the ability to override an enumerated policy result, with a policy exception depending on the specific contextual requirements.

For purposes of the present invention, the term “populating an entity” refers to the act of adding associated objects to the entity. Entities may not always be populated and as a result, empty entities may be defined and still provide relevance and usefulness to the description of a system, system component, or systems IT asset(s).

For purposes of the present invention, the term “ports, protocols and services management (PPSM) entity” refers to an entity that defines the list of user provided validated Network Access Rules, ACLs, or Policies that are approved for a given system or site. The functionality of a PPSM entity is defined as an access control that is designed to control data flows anywhere between the Layers of the OSI model. In embodiment of the present invention, a PPSM entity may be used to identify UAIs that sit outside of designated internal entities but inside of the premise entities. In embodiment of the present invention, a PPSM entity may be used in the PPSM process that Department of Defense (DoD) Organizations must follow and adhere to, for compliance. The PPSM process of the DoD requires the Organizations to document their required Ports, Protocols and Services needed to support the Organizations various activities and missions, etc.

For purposes of the present invention, the term “premise entity” and the term “Point of Presence (PoP)” refer to a defined entity that describes associated objects that conform to the systems, system components, or system IT Asset(s) documented architecture described as Premise or POP in relevance and function. The UAI in premise entities or PoP entities are technically owned by the Internet Service Provider (ISP) or circuit provider and NOT under the organization/system authority. In one embodiment of the present invention, a premise entity or PoP entity may be used to determine the demarcation point between the organization/system vs. non-organization/system.

For purposes of the present invention, the term “premise zone” refers to a physical or logical point in which the enclave connects to another enclave or system outside of an organization's administrative authority for the purpose of having access to the greater WAN or Internet. An premise zone is a portion of an enclave that traditionally been labeled as premise, external perimeter, enclave boundary, demarcation, circuit provisioned, Internet Service Provider (ISP), Service Provider, Approved Gateway (AG), Service Delivery Router, A premise zone may be referred to as a “Point-of-Presence (PoP)” or other synonymous term having relevance to the physical or logical point in which the enclave connects to another enclave or system outside of the organizations administrative authority for the purpose of having access to the greater WAN or Internet.

For purposes of the present invention, the term “processor” refers to a device that performs the basic operations in a computer. A microprocessor is one example of a processor. Various features of the present invention may be performed by one or more processors.

For purposes of the present invention, the term “restricted entity” refers to a defined entity that describes associated objects that conform to the systems, system components, or system IT Asset(s) documented architecture described as “restricted” in relevance and function. The UAI in a restricted entity are under the organization/system administrative authority. In embodiment of the present invention, a restricted entity may be used to define VLAN IDs or names in which asset ports/interfaces may be assigned for non-operational purposes.

For purposes of the present invention, the term “server entity” refers to a defined entity that describes associated objects that conform to the systems, system components, or system IT Asset(s) documented architecture described as “Server” or “Server Farm” or “Data Center” in relevance and function. The UAI in a server entity are under the organization/system administrative authority. The function of a server entity is as a servers which implies all manner of server services. Server IP spaces may be any functional location so long as it provides a known server service, such as Web, Printer, AD, Data Warehousing, etc.

For purposes of the present invention, the term “site” and the term “subsystem” refer to an individual unique component within an organization/system. A site is a physical or logical part of an organization that serves to distinguish itself from other sites within the organization. This contextual entity allows the users the ability to further define the organization/system based upon the “site/subsystem” principles, further creating granular levels of administrative and reporting domains.

For purposes of the present invention, the term “software entity” refers to a defined entity that describes associated objects that conform to the systems, system components, or system IT Asset(s) documented architecture described as “Software” in relevance and function. In one embodiment of the present invention, This entity defines the list of “Org./System” validated OS and Software versions that are approved for use in the system. The version functionality is clearly defined, synonymous terms for validated may be used depending on requirements. An example of its use is to define the list of Cisco IOS version approved for use by the Systems Change Control Board, or synonymous entity for approving changes within the system.

For purposes of the present invention, the term “special entity” refers to a defined entity or entities that describes associated objects that conform to the systems, system components, or system IT Asset(s) documented architecture however, are unable to fit into the more commonly used terms for entities that describe a system. The UAI for a special entity are under the organization/system administrative authority. A special entity provides a location to define UAIs that would extend further context awareness as needed.

For purposes of the present invention, the term the term “storage medium” refers to any medium or media on which data may be stored for use by a computer. Examples of storage include both volatile and non-volatile memories such as MRAM, ERAM, flash memory, RFID tags, floppy disks, Zip™ disks, CD-ROM, CD-R, CD-RW, DVD, DVD-R, flash memory, hard disks, optical disks, etc.

For purposes of the present invention, the term “system administrator” and “sysadmin” refer to a person or persons who are responsible for the upkeep, configuration and operations of one or more computer systems, i.e., the management responsibilities for a computer systems.

For purposes of the present invention, the term “system component” refers to a set of elements that forms a specific function or relevance to a system as a whole that is different from other components within the same system.

For purposes of the present invention, the term “system identifier” and the term “organization identifier” refers to the top level unique system/organization identifier for a system/organization. The compliance reporting tool of the present invention employs a structural starting point. This contextual object allows users the ability to frame the system/organization based upon organization/system principles, and to provide separate administrative domains for management and reporting purposes.

For purposes of the present invention, the term “system IT asset” refers to any hardware or software element that may or may not be owned by the Organization/System however is documented as an asset and relevant to the system.

For purposes of the present invention, the term “Unique Asset Identifier (UAI)” refers to the format by which the system may readily identify a unique asset. There are various formats in use today in which unique assets are managed such as IPv4 Address, IPv6 Address, MAC address, or Hostname (DNS or NetBIOS), Serial Number, or User-Defined. UAIs may be grouped according to their functions or by requirements and given a user-defined “Group Asset Identifier” (GAI). An example would be IP Subnets or VLAN IDs or Names, Workgroups, Domains, etc.

For purposes of the present invention, the term “user-defined entity” refers to an entity or entities specifically named by the user in which associated objects that conform to the systems, system components, or system IT Asset(s) documented architecture however, are unable to fit into the more commonly used terms for entities that describe a system. The UAI for a user-defined entity are under the organization/system administrative authority. A user-defined entity provides a location to define UAIs that would extend further context awareness as needed.

For purposes of the present invention, the term “validate” refers to the act of identifying the status, whether applicable, non-applicable, compliant or non-compliant of a system, system component, or systems IT Asset(s) configuration against a given policy, set of policies, or policy check(s).

For purposes of the present invention, the term “validated service account entity” refers to an entity that defines the list of user-defined validated service accounts and, if applicable, the privilege levels of the user-defined validated service accounts. These accounts may deviate from an organization's standardized account management systems, such as Active Directory, TACACS+, RADIUS, etc., but not limited to this function. A validated service group entity includes scope i.e. local, site, enterprise, etc. In embodiment of the present invention, a validated service account entity may to define a local emergency account for a given network device if access to the account management server, is not available. In embodiment of the present invention, a validated service account entity may to define a special service account for a given application that may exist on a specific number of devices only.

For purposes of the present invention, the term “validated user account entity” refers to an entity that defines the list of user-defined validated user accounts and, if applicable, the privilege levels of the user-defined validated user accounts. These accounts may deviate from an organization's standardized account management systems, such as Active Directory, TACACS+, RADIUS, etc., but not limited to this function. A validated user group entity includes scope i.e. local, site, enterprise, etc. In embodiment of the present invention, a validated user account entity may be used to define a local emergency account for a given network device if access to the account management server, is not available. In embodiment of the present invention, a validated user account entity may be used to define a special service account for a given application that may exist on a specific number of devices only.

For purposes of the present invention, the term “validated version entity” refers to an entity that defines a list of organization/system-validated operating system (OS) and software versions that are approved for use in a system. In embodiment of the present invention, a validated version entity may be used to define the list of Cisco IOS version approved for use by a Systems Change Control Board or similar entity for approving changes within a system.

For purposes of the present invention, the term “visual display device,” the term “visual display apparatus” and the term “visual display” refer to any type of visual display device or apparatus such as a an LCD screen, touchscreen, a CRT monitor, LEDs, a projected display, a printer for printing out an image such as a picture and/or text, etc. A visual display device may be a part of another device such as a spectrometer, a computer monitor, a television, a projector, a cell phone, a smartphone, a laptop computer, a tablet computer, a handheld music and/or video player, a personal data assistant (PDA), a handheld game player, a head mounted display, a heads-up display (HUD), a global positioning system (GPS) receiver, etc.

For purposes of the present invention, the term “VLAN entity” refers to a defined entity or entities that describes associated objects that conform to the systems, system components, or system IT Asset(s) documented architecture referencing “VLAN” in some form or another in relevance and function. In one embodiment of the present invention, a “VLAN Trunk entity” may be used to define the systems VLANs that are designated for specific Trunk/Port/Link Aggregation functionality.

For purposes of the present invention, the term “zone” and the term “area” refer to a physical or logical grouping of a computing environment. Zones may be further defined as a part of a system/enclave in which specific or common controls and functions are defined so as to distinguish itself from other subsets of a system/enclave. A zone is basically a logical or physical grouping of similar objects. In at least some cases VLANs could be considered synonymous with the term “zone.”

### DESCRIPTION

Due to the lack of standards for commercial compliance reporting toolsets, the National Institute of Standards and Technology (NIST) created Security Content Automation Protocol (SCAP). SCAP is a suite of specifications for organizing, expressing, and measuring security-related info in standardized ways, as well as related reference data such as unique identifiers for vulnerabilities. There are commercial responses to SCAP but they are based on NIST standards (Federal Desktop Core Configuration (FDCC) and United States Government Configuration Baseline (USGCB)) as opposed to DISA STIG standards and typically focus on operating system specific settings for Windows and Linux/Unix systems. The current products developed to do compliance testing on those host systems do not adequately cover networking devices such as routers, switches, VPN concentrators, etc. Additionally, there are gaps in compliance check capabilities focused on application specific settings, like Anti-Virus, Web Server, Mail Server, Database, etc.

Most compliance checks on the networking devices (as well as on host systems, applications, etc.) are extremely manually intensive. The DISA STIG checklists range from 10 to thousands of questions per device. These checks are conducted at many phases of the products lifecycle. During initial build-out, pre-validation, validation, and as part of an ongoing continuous monitoring program.

In one embodiment the present invention provides a means to enumerate a given set of standards i.e. Government, Commercial, etc., against an IT device, while referencing user provided context, applicable to the system as a whole. There are currently no automated systems that provide in-depth analysis beyond a simple, one layer technical check. For example, if check A=0, False, else If check A=1 true. The previous example provided is an analogy of today's current technical checks.

In one embodiment, the present invention provides a compliance reporting tool that not only improves the accuracy of these checks, but also saves valuable man-hours and money. In one embodiment, the present invention provides a compliance reporting tool that provides advantages over a manual, paper born, checklist processes that are out-of-date, slow, unreliable, unrepeatable, difficult to track, and prone to human errors. Currently, these checks may take hours per device every time the checks are conducted. In one embodiment the compliance reporting tool of the present invention may complete these checks on multiple devices in minutes.

In one embodiment, the compliance reporting tool of the present invention provides the capability of automating many of the mandatory, manually intensive, network devices compliance checks, such as. Initial focus will be on the Defense Information Systems Agency (DISA) Security Technical Implementation Guideline (STIG) checks. In one embodiment of the present invention, the compliance reporting tool of the present invention provides the capability to comply with Federal Information Systems Management Act (FISMA), Payment Card Industry Data Security Standards (PCI-DSS), the Health Insurance Portability and Availability Act (HIPPA), and other government and commercial security requirements. For each of these types of compliance checking, there is a move within their respective industries to approach “continuous monitoring” capabilities.

Due to the lack of standards for commercial compliance reporting toolsets, NIST created Security Content Automation Protocol (SCAP). SCAP is a suite of specifications for organizing, expressing, and measuring security-related info in standardized ways, as well as related reference data such as unique identifiers for vulnerabilities. There are commercial responses to SCAP but they are based on NIST standards (Federal Desktop Core Configuration (FDCC) and United States Government Configuration Baseline (USGCB)) as opposed to DISA STIG standards and typically focus on operating system specific settings for Windows and Linux/Unix systems. The current products developed to do compliance testing on those host systems do not adequately cover networking devices such as routers, switches, VPN concentrators, etc. Additionally, there are gaps in compliance check capabilities focused on application specific settings, like Anti-Virus, Web Server, Mail Server, Database, etc.

In one embodiment, the present invention provides a compliance reporting tool that automates DISA STIG checks for network infrastructure devices by collecting, storing, and analyzing data on one or multiple devices in minutes.

In one embodiment, the present invention provides a compliance reporting tool that significantly reduces auditing time, increases accuracy and utilizes a defined repeatable process. The benefits of this tool can be leveraged by Network Administrators, Engineers. Auditors, and Enterprise Vulnerability Management Teams during initial installation. Through continuous compliance and troubleshooting of broken devices, the compliance reporting tool according to one embodiment of the present invention improved solution to meet existing DoD requirements with a more accurate, effective, and efficient process resources.

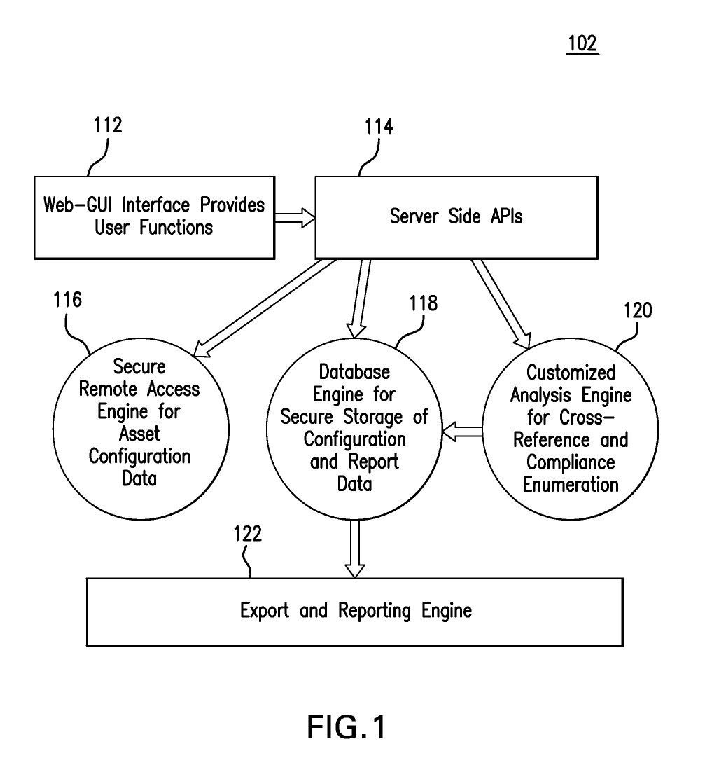

FIG. 1 is a diagram showing a compliance reporting tool 102 according to one embodiment of the present invention. Compliance reporting tool 102 includes six core components: web-based graphical user interface (GUI) 112, a server side Application Performing Interface (API) 114, a remote access engine 116, a database 118, an analysis engine 120, and a report generation and export facility module 122. GUI 112 provides a user experience for actionable items such as Defining a System and its individual contextual components. Discovering Devices, Creating and Executing Test Plans, etc. Server side API module 114 provides back-end processing between the six core components. In one embodiment of the present invention, Java/.NET may be utilized for back-end processing. Remote access engine 116 provides secure configuration data collection. In one embodiment of the present invention, remote access engine 116 may be TCL-based. Database 118 provides secure storage of site and configuration data. In one embodiment of the present invention, database 118 may be a database engine such as a mySQL/SQL database engine. Analysis engine 120 enumerates and stores data for compliance checks. In one embodiment of the present invention, analysis engine 120 is Export facility module 122 provides output for report export requirements. In one embodiment of the present invention, the output results may be in a XCCDF (XML) format and CSV format. In one embodiment the results may be in WIP format. The results may be displayed by the user on the user's visual display device (not shown in FIG. 1).

In one embodiment, the compliance reporting tool of the present invention consolidates and automates certification and accreditation (C&A) and continuous monitoring processes. In one embodiment, the compliance reporting tool of the present invention reports on a given network device (e.g. Cisco router, Juniper switch, etc.), host system (e.g. Windows or Linux computer, server, etc.), or system component (e.g. anti-virus application, server application. In one embodiment, the compliance reporting tool of the present invention automates the technical compliance checks that exist for a given industry's certification and accreditation process. In one embodiment, the compliance reporting tool of the present invention provides a common framework centralizing C&A processes in order to efficiently expedite policy based compliance checks. In one embodiment, the six core components of the compliance reporting tool of the present invention together provide a centralized, comprehensive and efficient, automated compliance solution.

In one embodiment of the present invention, the graphical user interface is a user interface allowing users to schedule tests of networked infrastructure, where a user can: set up the compliance reporting tool to do a network scan to find devices the system can scan, select device(s) for the compliance reporting tool to scan (either automatically found by the system or from input from the user), schedule the scan, and monitor the status of a scheduled/running/completed scan. In one embodiment of the present invention, the graphical user interface includes a reporting interface for: displaying results of individual scans, displaying aggregated results of multiple scans, and providing a dashboard of overall scanning status and results. In one embodiment of the present invention, the graphical user interface includes an administrative interface for system administration for allowing administrators to: add, modify and delete users, manage license keys for the system, and monitor the health of the system as a whole (uptime, scanning results, scheduled scans, etc.). In one embodiment of the present invention, the graphical user interface includes an administrative interface for scan configurations, allowing a user to: modify the details of a particular compliance requirement set, view the differences from one compliance requirement set to another (e.g. test differences from a localized version of a test against the standard produced by a compliance authority).

In one embodiment of the present invention, the database engine includes a datastore for storing the results of each scan and storing configurations for a scan (unique to each manufacture/device/version).

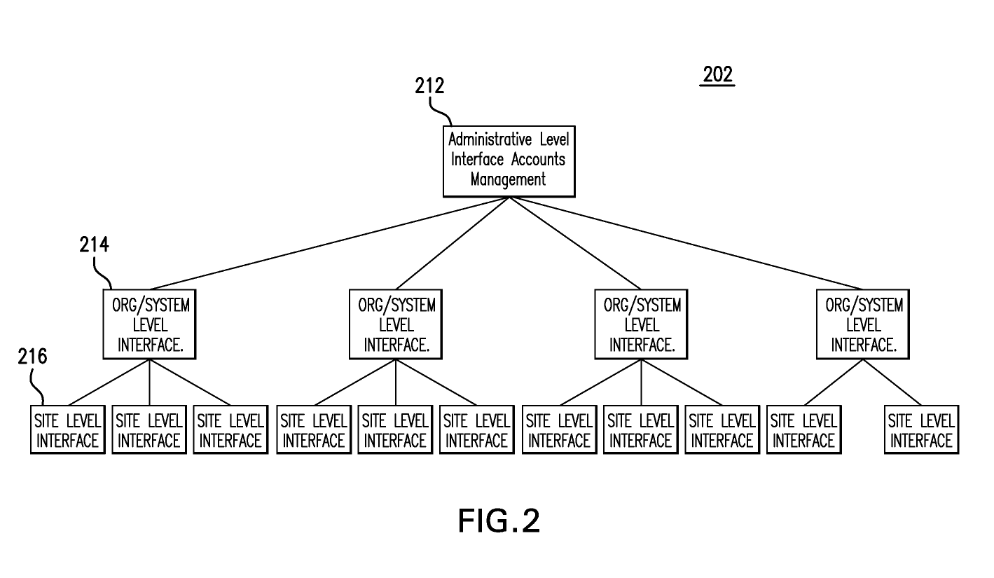

In one embodiment of the present invention, the GUI is a direct interface between a user and the suite of components that comprise the compliance reporting tool. FIG. 2 provides an overview of the logical structure of a GUI according to one embodiment of the present invention. FIG. 2 shows a hierarchy 202 having an administrative level GUI 212 at the top, organization-system level graphical user interfaces 214 below administrative level GUI 212 and several site level graphical user interfaces 216 below each organization-system level graphical user interface 214.

In one embodiment of the present invention, the administrative level graphical user interface provides: a web login page in which the user must enter localized credentials for the compliance reporting tool to access the compliance reporting tool, a default root level compliance reporting tool administrator account that must be logged in initially by the owner of the compliance reporting tool and a default admin page which belongs to the compliance reporting tool administrator account. In one embodiment of the present invention, the administrative level graphical user interface provides the administrator of the of the compliance reporting tool the ability to perform the following administrator interface level options: (1) create ‘user’ account.—create account and assign access privileges to an existing organization/system, (2) modify existing ‘user’ account, (3) delete existing ‘user’ account, (4) create an organization/system container, i.e., create an organization/system container and assign existing users to manage, (5) modify existing organization/system container, and (6) delete existing organization/system container.

In one embodiment of the present invention, the organization-system level graphical user interface provides a user an organization/system page that offers the user the ability to access the following options: (1) Logout (log out of GUI), (2) Change Password (change password to own user account), (3) Create a new site (create new site process), (4) Site menu selection (drop down menu election for created sites), (5) Security Guidelines (this page provides Security Guidelines such as DoD, NIST, etc., for reference). In one embodiment of the present invention, the organization/system page may display the following items for user consumption: (a) Master Dashboard Reports (top level compliance report summarizing the total combined compliance status for ALL sites latest test plan data. i.e. Highest level Rollup of most recent compliance data for all sites) and (b) Number of sites entered into the system (brief description of each site).

In one embodiment of the present invention, the organization-system level graphical user interface provides a user a Security Guidelines page that offers the user the ability to reference industry specific security guidelines and standards. e.g. DISA's entire STIG Library. In one embodiment of the present invention, the Security Guidelines page may provide: (1) a directory structure of Industry (Commercial and DoD) standards designed for Certification and Accreditation, (2) Filtering and Sorting capabilities, (3) query/search capabilities based upon user-defined keywords within a given documents file name, (4) query/search capabilities based upon user-defined keywords with a given files contents, (5) the ability for the user to open document within browser or save to user-defined file location, and (6) the administrator the ability to update/modify this library for updated content.

In one embodiment of the present invention, the Security Guidelines page may provide Filtering and Sorting capabilities based upon the following parameters: (1) Technology (2) Manufacturer, and (3) Industry.

In one embodiment of the present invention, the site level graphical user interface provides a user a Site page that includes a Navigation Menu for accessing the following items: (1) Site Info (this page contains all of the relevant site-specific information that is required for analysis, (2) Discover Devices (this page contains the procedures to discover a device and entering it into the database, (3) All Devices (this page displays devices that have been entered into the database), (4) Create Test Plan (this page contains the procedures to create a test plan for the devices in the database) and (5) All Test Plans (the page displays completed/archived test plans for historical analysis and management.) The Site page may also display the following items for user consumption: (a) Site level Dashboard reports (graphical compliance reports summarizing the overall status for the site) and (b) a Site level summary (number of devices currently in database, number of devices out of compliance, etc.)

In one embodiment of the present invention, the Site Info page provides a user the ability to enter the following data types that are required for site-specific compliance (and continuous monitoring) analysis: (1) Site Info (primary Site Description and “unique” Site Name/Code descriptor), (2) Site Personnel (contact Info for key personnel for a site), (3) Site Diagram (completed Logical diagram of the site), (4) Site PPSM (Approved Ports Protocols Services Management), (5) Site IP/Subnet Space (site specific IP subnets and LANs organized according to functional location, (6) Site IPv4 and IPv6 (Combined list of a Sites IP Subnets and LANs, (7) Site Device Functional Location (site specific assets organized according to functional location, (8) Site Policy Library (site specific policy documentation can be uploaded to this section), (9) Site Exceptions (site specific technical or policy checks that are exempted/deviated from standard requirements, and (10) Confirm (review and confirmation page for Site specific data).

In one embodiment of the present invention, the site level graphical user interface provides a user a Discover Devices page that offers the user the ability to discover a given device to be analyzed for compliance. The Discover Devices page may provide: (1) the interface to enter device credentials prior to performing a discover request, (2) the option to add the device into the database once it is discovered

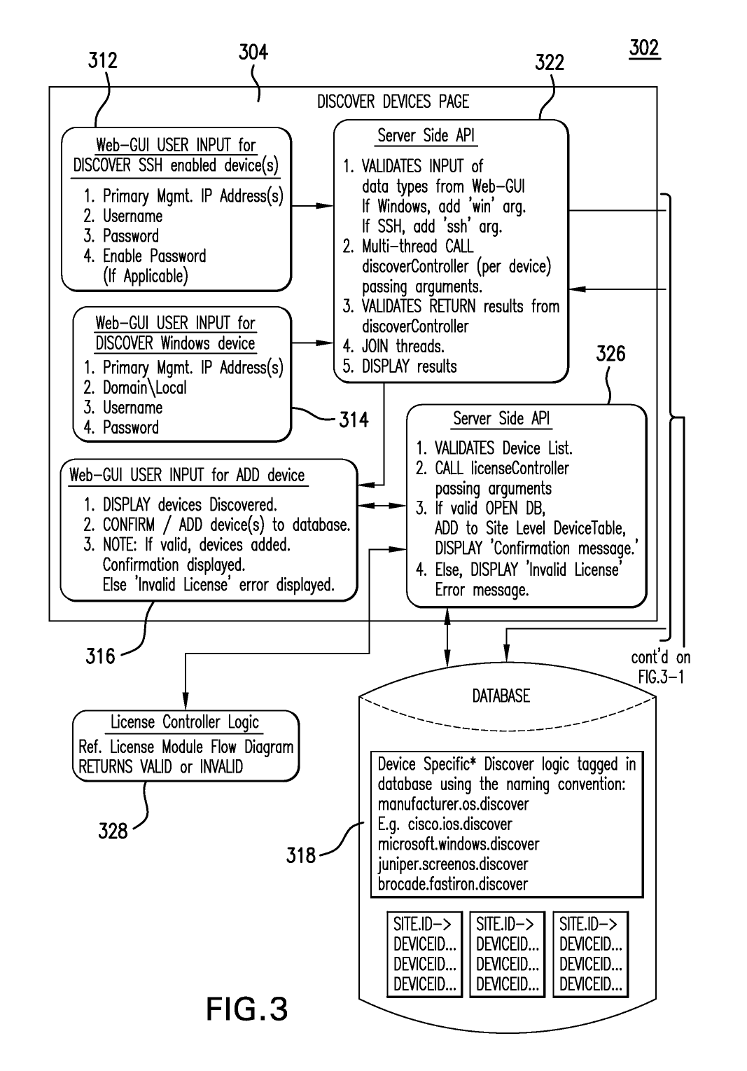

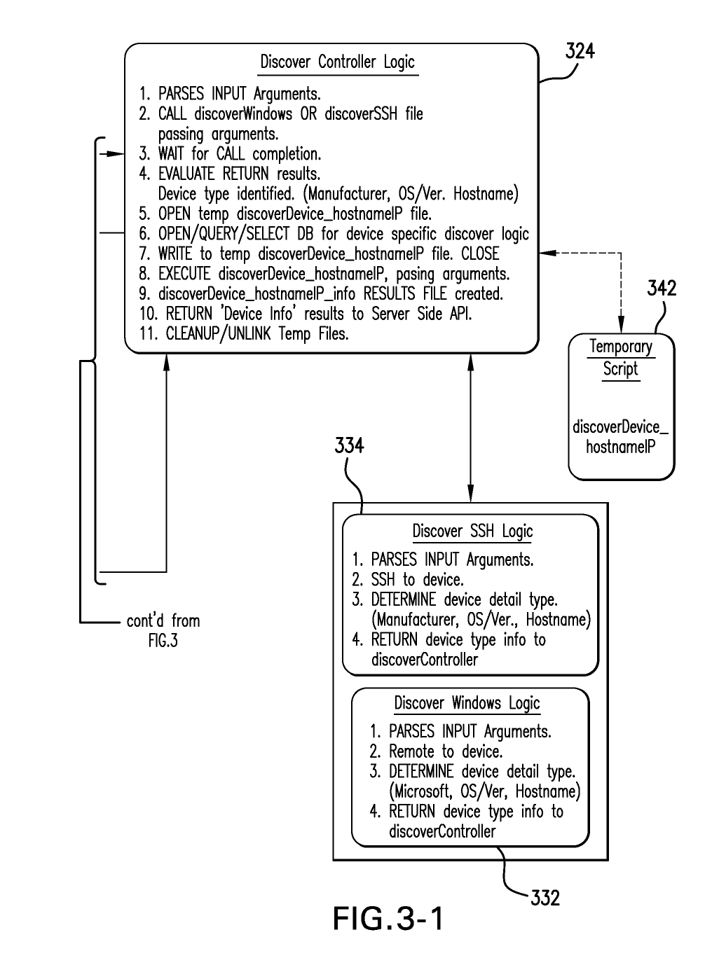

FIGS. 3 and 3-1 show a Device Discovery Process Flow Diagram 302 for a Discover Devices page 304 according to one embodiment of the present invention. Diagram 302 shows the options, i.e., options 312 and 314, presented to the user on the Discover Devices page. For option 312, the Discover Devices page requests user input information to prove that the user has the credentials necessary to allow the user to discover a secure shell (SSH) enabled device(s). The information requested includes: the primary management IP addresses, a username, a password and an enable password, if applicable (Some network devices use a secondary “Privileged Exec” level password dubbed “enable” due to having to type in the command “enable”. Not all network devices require this secondary password). For option 314, the Discover Devices page requests user to input information to prove that the user has the credentials necessary to allow the user to discover Windows device(s). The information requested includes: the primary management IP addresses, the name domain and/or local server, a username and a password. After the devices are discovered, the devices discovered are displayed to the user as indicated in subroutine 316. The user may then confirm one or more of the devices should be added to database 318. If valid devices are added, confirmation is displayed to the user.

For the server side API for option 312 or option 314, as indicated in subroutine 322, the server validates input of data types entered by the user. If the device is a Windows device, a ‘win’ argument is added. If the device is a secure shell (SSH) device, an ‘ssh’ argument is added. Then a multithread discover controller subroutine 324 is called for each device that passes the respective argument(s). The return results are validated from discover controller subroutine 324. Then the threads are joined and the results are displayed.

For the server side API for subroutine 316, as indicated in subroutine 326, the server validates the device list. Then license controller subroutine 328 is called to pass the arguments. If valid, the database is opened, and the line Display ‘Confirmation message” is added to the site level device table. If not valid, the line Display ‘Invalid License’ error message is added to the site level device table.

In discover controller subroutine 324, the input arguments for are passed. Then discover Windows subroutine 332 or discover SSH subroutine 334 is called. Then discover controller subroutine 324 waits for the call completion. Then the return results are evaluated and the device type identified. Then a temporary discover device hostname IP file 342 is opened. Then step in which an open/query/select database operation for device specific discover logic is performed. Then a write is performed to temporary discover device hostname IP file 342 and file 342 is closed. Then temporary discover device hostname IP file 342 is executed thereby passing the arguments in file 342. A device info results file is created for the information from temporary discover device hostname IP file 342. Then device info results file is returned to the server side API. Then each of the temporary discover device hostname IP file 342 for the devices are cleaned up and/or unlinked.

When called, discover Windows subroutine 332 is called, subroutine 332 parses the input arguments. Then subroutine 332 remotely connects to the device. Then subroutine 332 determines the device type and other information about the device. Then subroutine 332 returns the device type information to discover controller subroutine 324 as a temporary configuration file.

When called, discover SSH subroutine 334 is called, subroutine 334 parses the input arguments. Then subroutine 334 SSH to the device. Then subroutine 334 determines the device type and other information about the device. Then subroutine 334 returns the device type information to discover controller subroutine 324 as a temporary configuration file.

In one embodiment of the present invention, the site level graphical user interface provides a user an All Devices page that offers the user the ability to review and manage each device entered into the database. The All Devices page may provide the user the ability to: (1) review the entire list of devices entered into the sites database, (2) sort devices based upon pre-defined, user selected criteria, (3) select a device and open a device page for updating its modifiable properties, (4) review and/or update/modify a given devices' modifiable properties.

Each device may be contained within its own single page view. Any given devices' device page may be accessible via the All Devices page. Any given device's device page will be accessible via a link to the page wherever the device name is referenced anywhere within the entire Sites Directory. The device page may provide a user the ability to review the following criteria for accuracy: (1) hostname, (2) manufacturer, (3) model, (4) firmware, (5) operating system, (6) operating system version, (7) functional location, (8). management IP (Primary), (9) active IP interfaces, (10) relevant security guidelines, (11) last executed test plan name, (12) last executed test plan time, (13) last executed test plan status, (14) next scheduled test plan info, (15) summarized findings of last successful test plan, (16) not applicable rules count of last successful test plan, (17) incomplete/manual rules count of last successful test plan, (18) completed rules count of last successful test plan, (19) graphical summary report of the last successful test plan, and (20) top 10 summary reports of the last successful test plan.

In one embodiment of the present invention, the site level graphical user interface provides a user a device edit page that offers the user the ability to edit/modify the following criteria for accuracy: (1) hostname, (2) manufacturer, (3) model, (4) firmware, (5) operating system, (6) operating system version, (7) functional location, (8) active IP interfaces and (9) relevant security guidelines.

In one embodiment of the present invention, the site level graphical user interface provides a user a Create Test Plan page that offers the user the ability to select the necessary components that are required to perform test plan generation and subsequent analysis. In one embodiment of the present invention, the Create Test Plan page may provide the user the ability to: (1) select a list of available devices for test plan generation and (2) assign a unique name to the test plan. In one embodiment of the present invention, the site level graphical user interface provides a Test Plan page that offers the user the ability to run (execute), re-run, delete, and review the details of a generated Test Plan and its subsequent detailed results.

FIGS. 4, 4-1 and 4-2 show a Test Plan Execution Process Flow Diagram 402 for creating and conducting test plans according to one embodiment of the present invention. A user is presented with an option, shown in process box 412, on a Create a Test Plan page to select devices from a list. Then the user is asked to assign a name to a test plan for the devices selected. Then the user confirms and/or creates the selection, causing a Test Plan page to open in which a user is presented with an option, shown in process box 414, to validate the selection of the test plan (Upon hitting an “Execute” button, a “credential pop-up” window appears in which the user must enter valid credentials for the Test-plan to actually continue).

After the test plan is created a pop-up appears as part of the site level graphical user interface to confirm the user's credentials to access and test the device as shown in process box 416. To prove the user's credentials to access and test a Windows device, the user is requested to provide the name of a domain and/or local server, a username and password. To prove the user's credentials to access and test an SSH device, the user is requested to provide a username, password and possibly an enable password. After the credentials are validated, the test plan is executed and the results displayed to the user as shown in process box 418.

The test plan selected by the user is created by a server executing subroutine 420. In subroutine 420 the input of data types from the user is validated. If the devices is a Windows device, ‘win’ is added to the argument. If the device is an SSH device, ‘ssn’ is added to the argument. A database 422 is queried for the device IP list. Then a new Test Plan Data structure with a unique test plan ID is created and added to database 422.

Subroutine 424 validates the input of data types from user. If the devices is a Windows device, ‘win’ is added to the argument. If the device is an SSH device, ‘ssh’ is added to the argument. The credentials of the user are requested. Then database 422 is quested for the test plan ID created by subroutine 420. Then a test plan controller subroutine 426 is called with arguments. The call is then completed and database 422 is queried for test plan results for the test plan. The test plan results are then displayed to the user.

Test plan controller subroutine 426 parses input arguments. Then subroutine 426 queries database 422 for the test plan ID and device ID input by the user. Then subroutine 426 creates a list for query. Subroutine 426 then opens and writes a temporary script file. Subroutine 426 then executes a thread call to temporary script file for each device. Subroutine then waits for each call to complete. Then subroutine 426 joins the threads, unlinks the temporary files and disconnects the server from the database.

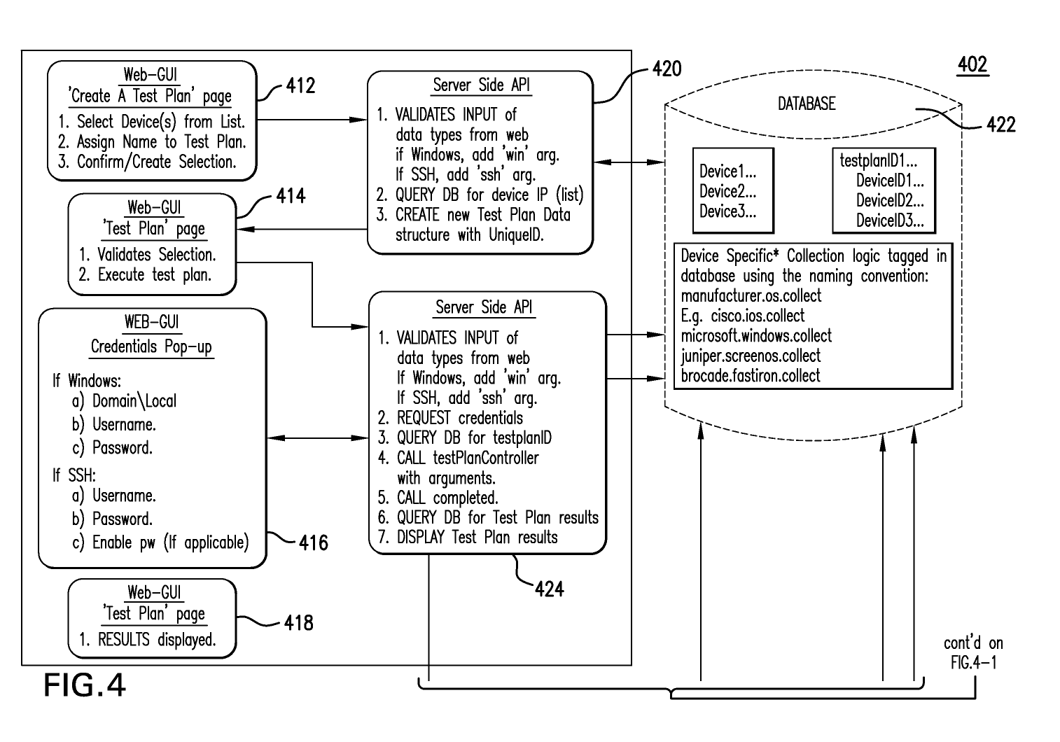

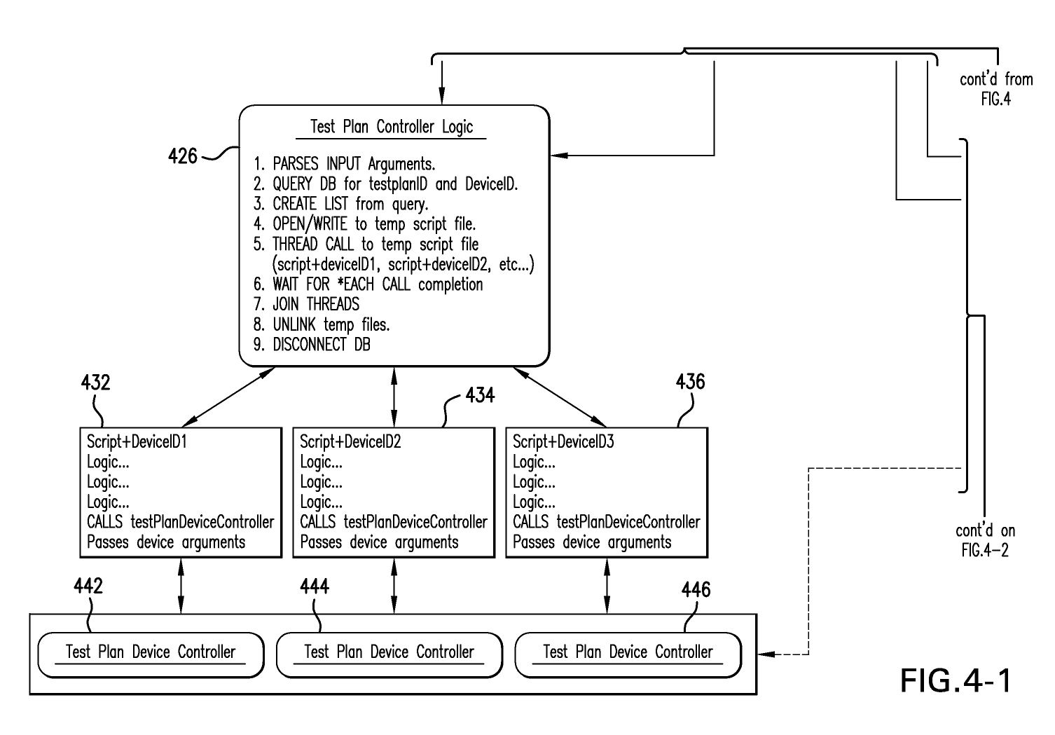

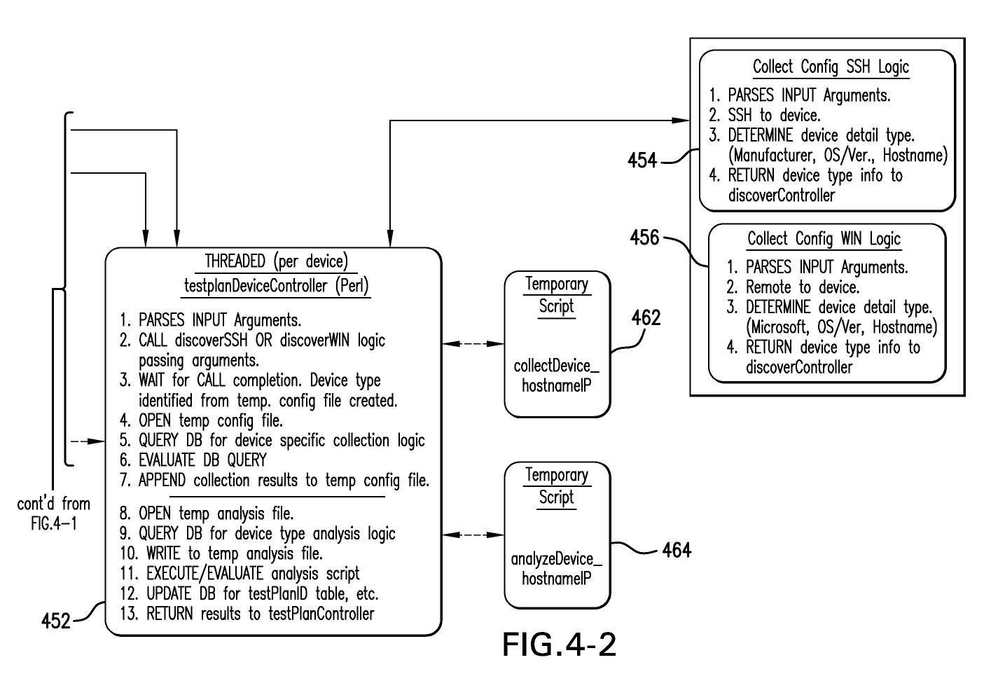

In FIG. 4, there are three devices, i.e., Device ID 1, Device ID 2 and Device ID 3, and therefore, three temporary script files 432, 434 and 434, one for each device. Temporary script files 432, 434 and 436 call test plan device controller subroutines 442, 444 and 446, respectively. Test plan device controller subroutines 442, 444 and 446 each perform subroutine 452 for one of the three devices.

Subroutine 452 parses the input arguments. If the device is an SSH device, then discover SSH subroutine 454 is called. If the device is a Windows device, then discover Windows subroutine 456 is called. Then subroutine 452 wails for completion of the call. Subroutine identifies the device type from a temporary configuration file 462 created by subroutine 454 or 456. Subroutine 452 opens the temporary configuration file. Subroutine 452 then queries database 422 for device specific collection logic. Then subroutine evaluates the database query. Then subroutine 452 appends the collection results to a temporary configuration file 462. Then subroutine 452 opens a temporary analysis file 464. Then subroutine 452 queries database 422 for device type analysis logic and writes the result of this query to temporary analysis file 464. Subroutine 452 then executes and evaluates an analysis script of temporary analysis file 464. Then subroutine 452 updates database 422 with information for the test plan ID table, etc. Then subroutine 452 returns results to test plan controller subroutine 426.

When called, discover SSH subroutine 454 is called, subroutine 454 parses the input arguments. Then subroutine 454 SSH to the device. Then subroutine 454 determines the device type and other information about the device. Then subroutine 454 returns the device type information to subroutine 452 as a temporary configuration file.

When called, discover Windows subroutine 456 is called, subroutine 456 parses the input arguments. Then subroutine 456 remotely connects to the device. Then subroutine 456 determines the device type and other information about the device. Then subroutine 456 returns the device type information to subroutine 452 as a temporary configuration file.

In one embodiment of the present invention, the test plan page provides a user to review the following properties of a test plan: (1) Test Parameters such as: Test Plan Name, Start Execution Timestamp, End Execution Timestamp, etc.; (2) Collection Parameters such as: Devices Targeted, Start Collection Timestamp, End Collection Timestamp, Completed collections as a percentage for ALL devices in the Test Plan. Total Collections Completed Count, Total Collections Incomplete Count, etc.; (3) Analysis Parameters such as: Security Guidelines selected for Analysis count, Start Analysis Timestamp, End Analysis Timestamp, Completed Analysis as a percentage for ALL devices in the Test Plan. Total Analysis Completed Count, Total Analysis Incomplete Count; and (4) List of Test Plan Devices Analysis results such as: Displayed by each relevant and associated Security Guidelines, etc.

Each Security Guideline is displayed by each of the following results parameters: (a) Unique Check ID, Rules ID (If applicable), Check or Rule Description; (b) Failures by Severity—High (Cal), Medium (Cat2), Low (Cat3); and (c) c) Totals—Pass or Fail.

In one embodiment of the present invention, the test plan page provides a user the ability to sort Security Guidelines results by the following parameters: (1) Unique Check ID, (2). Rules ID (If applicable), (3) Check or Rule Description, (4) Failures by Severity, such as High (Cal), Medium (Cat2), Low (Cat3), etc., and (5) Pass or Fail.

In one embodiment of the present invention, the test plan page provides a user the ability to select an individual check for detailed analysis. This ability is accessible via each individual device within the Test Plan by each individual security guideline rule/check.

In one embodiment of the present invention, the test plan page provides a user the ability to review graphical charts based on the following parameters: (1) Compliance Percentage Pie Chart summarizing the Test Plans combined results by Severity (High/Medium/Low) Passes, and Manuals; (2) Total Rule Status Pie Chart summarizing the Test Plans combined results by Passes, Fails, Not Applicables, Manuals, and Errors (Undocumented Check results); (3) Top 10—Failed Count by MAC Level/Severity Table-Filterable by Severity (High/Medium/Low); (4) Top 10—Failed Rules by Severity Table—Filterable by Severity (High/Medium/Low); and (5) Top10—Failed IA Controls by Severity Table—Filterable by Severity (High/Medium/Low).

In one embodiment of the present invention, the test plan page provides a user the ability to export the results data into the following formats: (1) Comma Separated Values—.csv; (2) Extensible Markup Language—.xml—This is further categorized into the following formats: (a) XCCDF—Extensible Configuration Checklist Description Format as defined by DISA, (b) VMS—Vulnerability Management System Format as defined by DISA, etc.

In one embodiment of the present invention, the site level graphical user interface provides a user a Rule and Check Definition Results page that offers the user the ability to review and, if required, update the Test Plan results of an individual Rule or Check. The Rule and Check Definition Results page may display the full definition parameters. The Rule and Check Definition Results page may display the appended automated analysis results parameters: (1) Status Column (Pass, Fail, Not Applicable, and Manual) provided by Analysis engine; (2) Analysis Results Column (Pre-defined results verbiage provided by Analysis engine); (3) Configuration Parameters Column (Relevant configuration parameters provided by Analysis engine); (4) Manual Comments Column—Reserved for Manually provided results data by the user; and (5) Override Log Column (Default is ‘No data’). If override flagging occurs, update and append user account and timestamp to column

In one embodiment of the present invention, the Rule and Check Definition Results page provides the user the ability to update/modify the following Analysis results parameters: (1) Status Column (NOTE: If manual override occurs, flagging of Override Log Column captures override details); (2) Manual Comments Column (Provided by user to document changes, Updated configuration data is appended here as well)

In one embodiment of the present invention, the site level graphical user interface provides a user an All Test Plans page that offers the user the ability to review and display results on historical Test Plan data sets. level.

In one embodiment of the present invention, the compliance reporting tool includes a server side API component that provide all the necessary functions that are required, allowing the individual core components to interact where applicable.

In one embodiment of the present invention, the compliance reporting tool includes database component that acts as a data store for all data-at-rest applicable to the functionality of the compliance reporting tool. In one embodiment of the present invention, the database component may be locked down and inaccessible to any administrator and/or users. The data should only be accessible via Server Side API calls and should be secured from all other Non-Server Side API access. in one embodiment of the present invention, the database may contain all the required data structures that service all the core components, where applicable: (1) the web-based graphical user interface (the Database component will contain the main data structure supporting the web-based GUI), (2) Remote Data Collection (The Database component will serve as the configuration repository for data collected by the Remote Access and Configuration Data collection engine); (3) Analysis Engine (The Database component will serve as the repository for the customized analysis code for a given check); and (4) Report Generation and Export Facility (The Database component will serve as the repository for all of the raw Test Plan results. All Reports and Exports will query the database when referencing the data).

With respect to the web-based graphical user interface, the database component may contain an Administrator level data structure that supports and manages the administrative functions of the compliance reporting tool, such as Account Creation, Organizational and System level data structure creation, and Assigned account access to each Organizational and System level data structure. For each Organizational and System level data structure that is created by the administrator for the compliance reporting tool, the database component will provide the user the ability to create Site Level data structures that supports and manages the user functions such as Site Info, Device Discovery and Management, Test Plan creation and Management.

In one embodiment of the present invention, the database component may provide some form of data encryption to ensure basic data confidentiality.

In one embodiment of the present invention, the remote access and configuration data collection (RDC) components may provide the server side API the methods in which to access devices remotely, perform a series of data collection commands, and return the results to the API for entry into the database. In one embodiment of the present invention, the RDC component may utilize: (A) the latest stable version of Cygwin with only the following libraries installed: (1) Expect (TCL), and (2) OpenSSH (Net); (B) TCL's Expect Module and Open SSH to remotely access and collect relevant configuration data from SSH enabled (Non-Windows) devices; and (C) Windows PowerShell and Windows Management Instrumentation (WMI) to Remotely Access and collect relevant configuration data from Windows based devices. In one embodiment of the present invention, the remote access and configuration data collection (RDC) components may only utilize commands that are “read-only” in nature (unless otherwise specified. e.g. paging commands such as Cisco's [terminal Pager 0] may be necessary for proper data collection.

In one embodiment of the present invention, the RDC component may receive from the Server Side API, the following device specific parameters: (1) Primary Management IP address (defined at the web-based GUI); (2) Temporary File name (Defined by the Server Side API); (3) Administrative Account (defined at the web-based GUI); (4) Administrative Password (defined at the Web-GUI); and (5) Executive Level (Enable) password, if Applicable (defined at the web-based GUI).

In one embodiment of the present invention, the Security and Compliance Checks Analysis components may provide the Server Side API the methods in which to enumerate a given set of checks against a given devices configuration and site specific parameters. In one embodiment of the present invention, the analysis component may comprise of a library of scripted language modules and script files for analysis and flow control. In one embodiment of the present invention, the analysis component may utilize the latest stable version of Strawberry Pert (32-bit codebase ONLY). In one embodiment of the present invention, the analysis component may require a targeted “OS specific” analysis file for each Manufacturers OS. In one embodiment of the present invention, the analysis component may require each analysis code, for Operating System compliance checks, tagged with the following naming conventions: (1) Manufacturer; (2) Operating System; and (3) CheckID, e.g. cisco.ios. v-3012; cisco.asa. v-3012; brocade.fastiron. v-3012; brocade.nos.v-3012; juniper.screenos. v-3012 microsoft. windows 7. v-3012; microsoft. windowsserver2008. v-3012; red hat. fedora. v-3012; red hat. enterprise. v-3012; centos.centos. v-3012, etc.

In one embodiment of the present invention, the analysis component may require each analysis code, for Application level compliance checks, tagged with the following naming conventions: (1) Manufacturer; (2) Application; (3) Operating System; and (4) CheckID, e.g. symantec.sep. windows8. v-6359; symantec.sep. windowsserver2008. v-6359; microsoft.exchange. windowsserver2008. v-33573

In one embodiment of the present invention, the Report Generation and Export Facility (RGEF) of a compliance reporting tool of the present invention may offer the a user the ability to access various levels of pre-defined reports and export capabilities for integration into external tools or post-process requirements.

In one embodiment of the present invention, the RGEF may provide a user the ability to save all graphical reports that are viewable from the Web-GUI to file as any of the following formats: .jpg, .png, .bmp, etc. In one embodiment of the present invention, the RGEF may provide the user the ability to export a test plans results by the following parameters: (1) By “Individual” checklist results per device (if more than one checklist was referenced); (2) By “Combined” checklist results PER device (if more than one checklist was referenced); (3) By ‘Device’ selection (all checklists referenced); and (4) By Test Plan (all Devices, All Checklists).

In one embodiment of the present invention, the RGEF may provide a user the ability to save exported results into the following formats: (1) CSV (Comma Separated Value) and (2) XML (Extensible Markup Language).

In one embodiment of the present invention, the RGEF may provide a user the ability to select from several XML based formats: (1) SCAP XCCDF compliant specification. NIST/Open source community format; (2) DISA XCCDF compliant specification (current DoD/DISA STIG checklist formatting); and (3) DISA VMS compliant specification (current DoD/DISA System tracking specification).

In one embodiment of the present invention, the RGEF may provide a user the ability to sort test plan data based on the following fields: (1) Device Hostname; (2) CheckID; and (3) Check Results (Pass/Fail/Not Applicable/Manual).

In one embodiment of the present invention, the compliance reporting tool of the present invention may as a system run on top of a Microsoft Windows Embedded Server XX OS platform. In one embodiment of the present invention, the compliance reporting tool may utilize only the necessary operating system services to support the functional requirements of the compliance reporting tool. In one embodiment of the present invention, the operating system may be locked down from external and/or remote administrative access and local administrative access will only be granted for OS maintenance purposes.

In one embodiment of the present invention, the operating system may have all non-essential accounts disabled or deleted. In one embodiment of the present invention, the operating system may employ firewall services to disable ALL unnecessary ports and protocols that are not In direct support of the compliance reporting tool's functional requirements. In one embodiment of the present invention, the operation system may be updated to the latest security patches and service packs where applicable. In one embodiment of the present invention, the operating system may remove all web browsing capabilities. In one embodiment of the present invention, the operating system may remove all Domain Name Resolution and Resolving capabilities.

In one embodiment of the present invention, the compliance reporting tool may implement security considerations across each of six core components, i.e., web-based GUI, a server side API, a remote access engine, a database, an analysis engine, and a report generation and export facility module.

In one embodiment of the present invention, each site maintains its own set of “site” level contextual entities. As mentioned previously, the list is not all-inclusive, but provides a starting point. Further entities may be added or modified depending on the requirements of each site or system.

Having described the many features and advantages of the present invention in detail, it will be apparent that modifications and variations are possible without departing from the sphere and the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated. Accordingly, it is intended that the present invention not be limited to the described embodiments, but that it has the full scope defined by the language of the following claims, and equivalents thereof.

### EXAMPLES

In the examples below, an item on a window or page may be “selected” in any convenient fashion such as clicking on the item with a mouse or trackball, tap the item on touch screen, selecting the items with keyboard controls, etc.

### Example 1

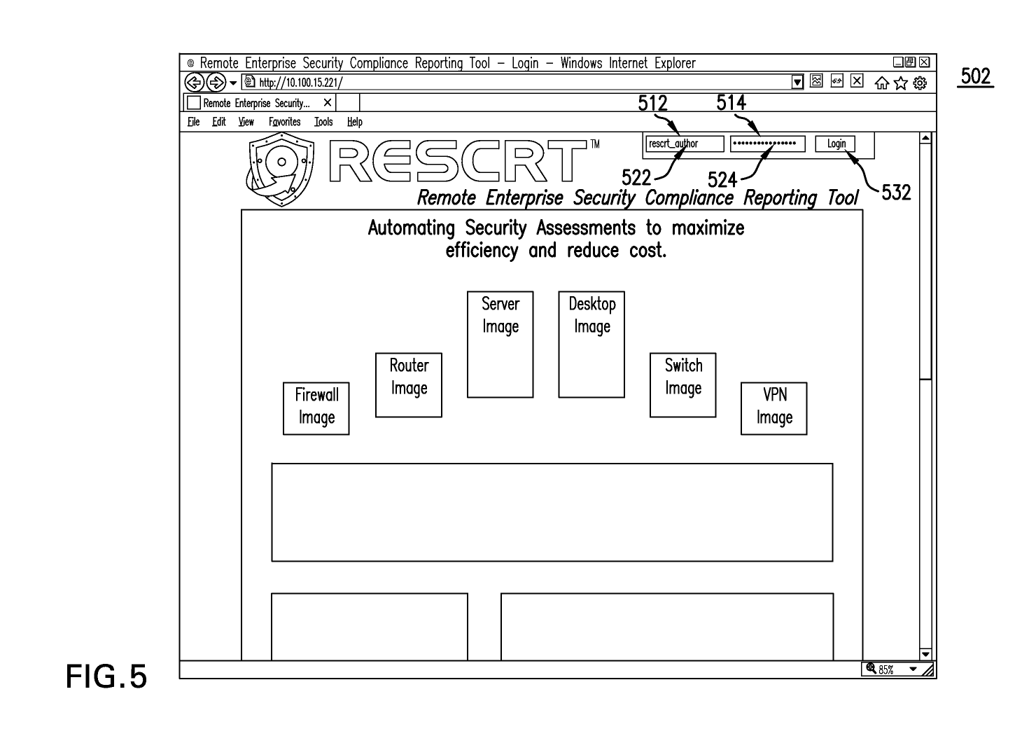

The operation of a compliance reporting tool according to one embodiment of the present invention is described in this example. Using a web browser, a user logs onto a web-site for the compliance reporting tool and is presented with a Login page 502 shown in FIG. 5. On Login page 502 a user types in the user's username 512 and password 514 in entry boxes 522 and 524, respectively and presses Login button 532.

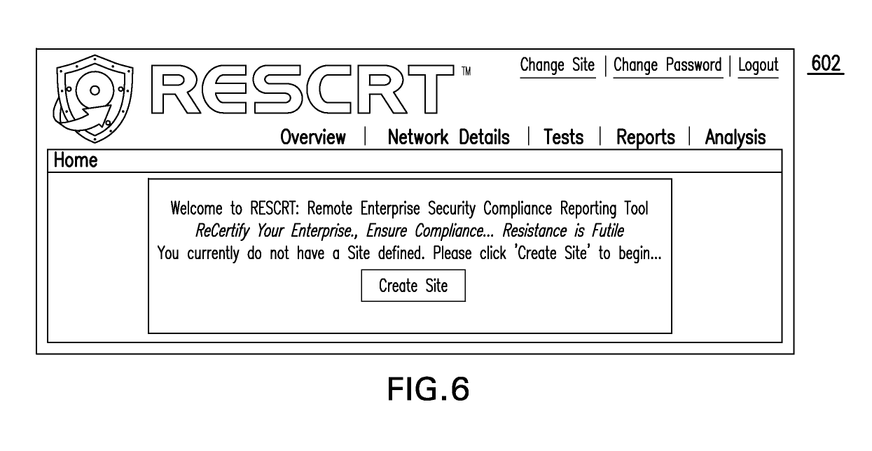

If a user is logging in for the first time, as shown in FIG. 6, the user may see “Create Site” page 602 and the user follows the instructions to create a site.

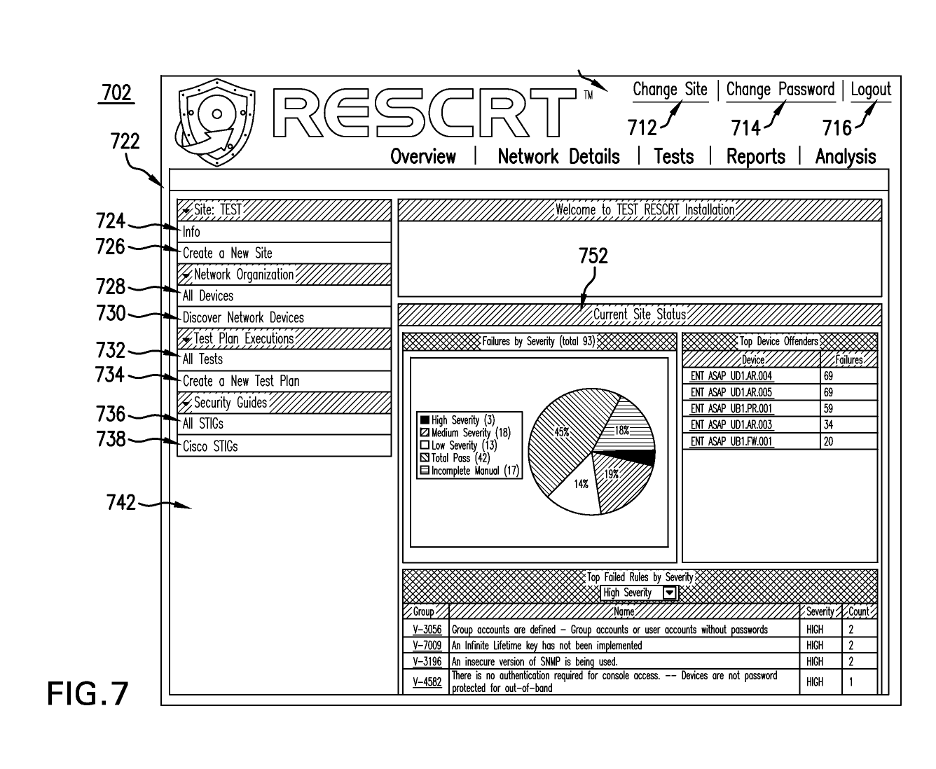

Once authorized, as shown in FIG. 7, the user is taken to a home page 702 for the compliance reporting tool that includes the following key areas: Navigation links 712, 714 and 716 on a top portion 718 of home page 702 for Change Site, Change Password, and Logout, respectively; a Main menu 722 including: Info link 724, Create New Site link 726, All Devices link 728, Discover Network Devices link 730, All Tests link 732, Create a New Test Plan link 734, All STIGs link 736 and Cisco STIGS link 738 on a left portion 742 of home page 702 for accessing functions of the compliance reporting tool. By selecting Info link 724, a user is provided Site Specific Information relevant to the current site. By selecting Create a New Site link 726, Create a New Site page is displayed to the user. The compliance reporting tool of this example is designed around a “site” organizational structure. By selecting All Devices link 728, an All Devices is displayed to the user that allows the user to manage “site specific” devices. By selecting labeled Discover Network Devices link 730, a Discover Networks Devices page is displayed to the user that allows the user to use the compliance reporting tool to discloser “site specific.” By selecting All Tests link 732, an All Tests page is displayed to the user that allows the user to manage “site specific” test plans and provides the user with STIG analysis results history. By selecting Create a New Test Plan link 734, a Create a New Test Plan page is displayed to the user that allows the user to manage the creation of each test plan. By selecting All STIGs link 736, an All STIGs page is displayed to the user that provides the user with STIG viewer of DISA's STIG content library. By selecting Cisco STIGS link 738, a Cisco STIGS page is displayed to the user that provides the user with a pre-defined STIG viewer to currently supported technologies.

Home page 702 also provides a visual representation of each function of each compliance reporting tool. In FIG. 7, home page 702 displays an overall site compliance status 752.

A basic organizational structure of a C&A environment is a “Site” A site may be as small as a single networking device at a remote location, or as large as a Network Operations Center or Data Center containing hundreds to thousands of networked devices. System owners or validators should build sites based around the organizational structure of the system to be validated.

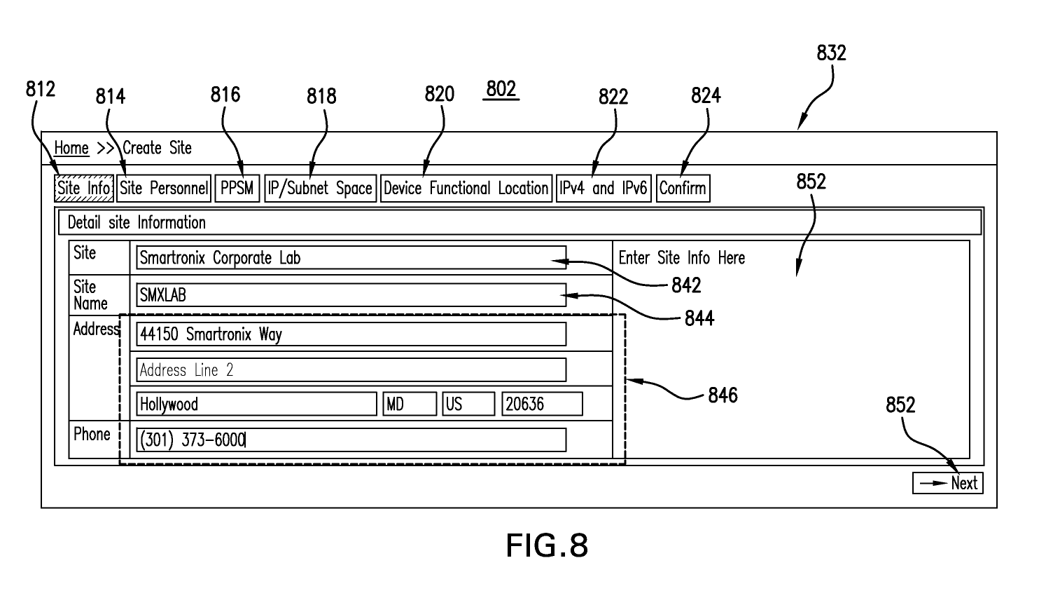

From home page 702, a user can create new site by selecting link 726 on the left main navigation menu. Create a Site page 802, shown in FIG. 8, will then be displayed to the user. Create a Site page 802 includes the following tabs: Site Info tab 812, Site Personnel tab 814, PP SM tab 816, IP/Subnet Space tab 818, Device Functional Location tab 820, IPv4 and IPv6 tab 822 and Confirm tab 824. In FIG. 8, Site Info tab 812 has been selected thereby opening Site Info page 832.

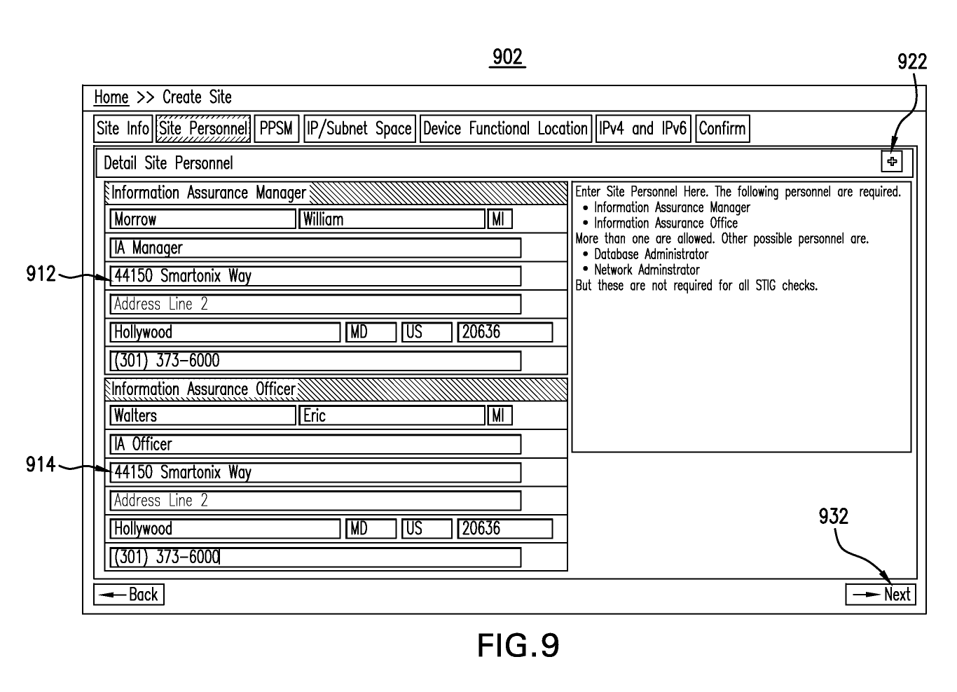

As shown in FIG. 8, Site Info page 832 displays a user entry box 842 for entering a site a Primary Site Description, a user entry box 844 for entering a unique Site Name/Code descriptor, entry boxes 846 for entering address and phone information for the site, and an entry box 852 for entering additional information about the site. Selecting Next button 862 or directly selecting Site Personnel tab 814 opens Site Personnel page 902 as shown in FIG. 9.

FIG. 9 shows Site Personnel page 902 for contact Info for key personnel for a site. The minimum requirement for Site Personnel page 902 is to enter the primary Information Assurance Manager and the Information Assurance Officer responsible for this site. It is possible that one individual may be performing both duties, however, it is still necessary need to enter the same information in Information Assurance Manager section 912 and in Information Assurance Officer section 914. Site Personnel page 902 also includes a plus sign button 922 and a Next button 932

The more thorough a site's list of personnel, the better and more informed users can be when it comes to quickly locating key individuals for action. Sites may have multiple key personnel.

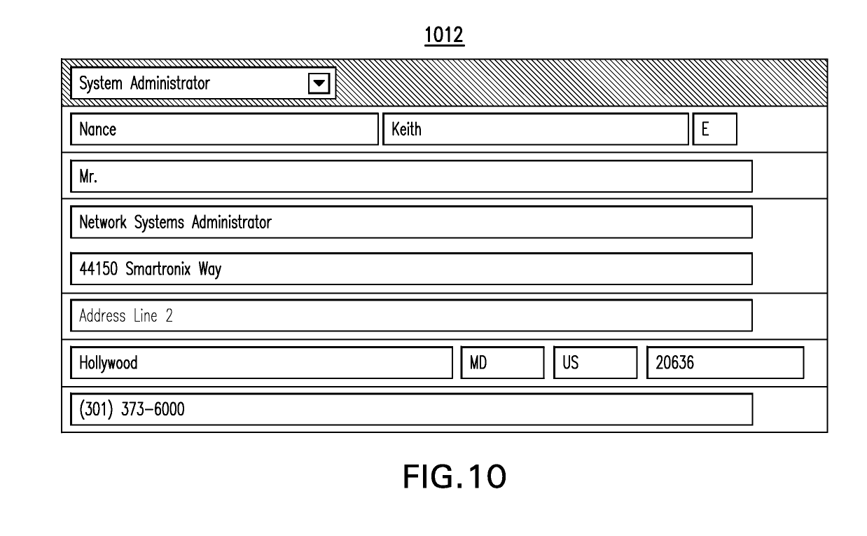

To add another contact, a user locates and selects plus sign button 922 on the top right of Site Personnel page 902. A new box 1012 is then displayed to the user as shown in FIG. 10 and the user can enter the appropriate information.

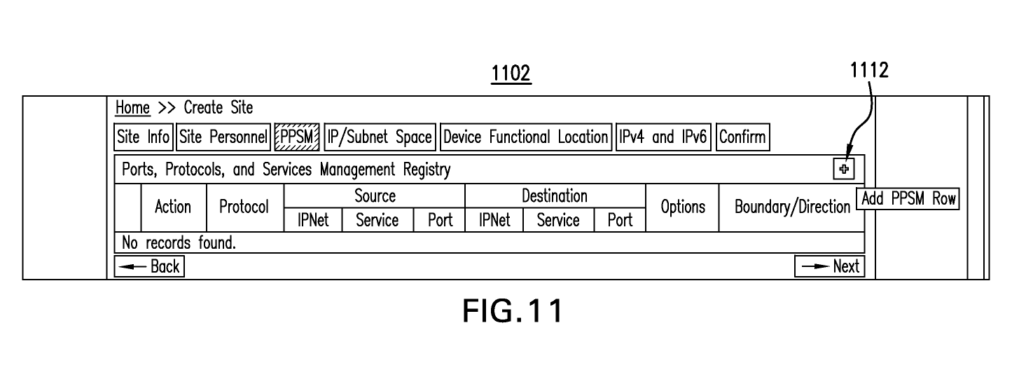

On Site Personnel page 902, selecting Next button 932 or directly selecting PPSM tab 816 opens PPSM page 1102 shown in FIG. 11.

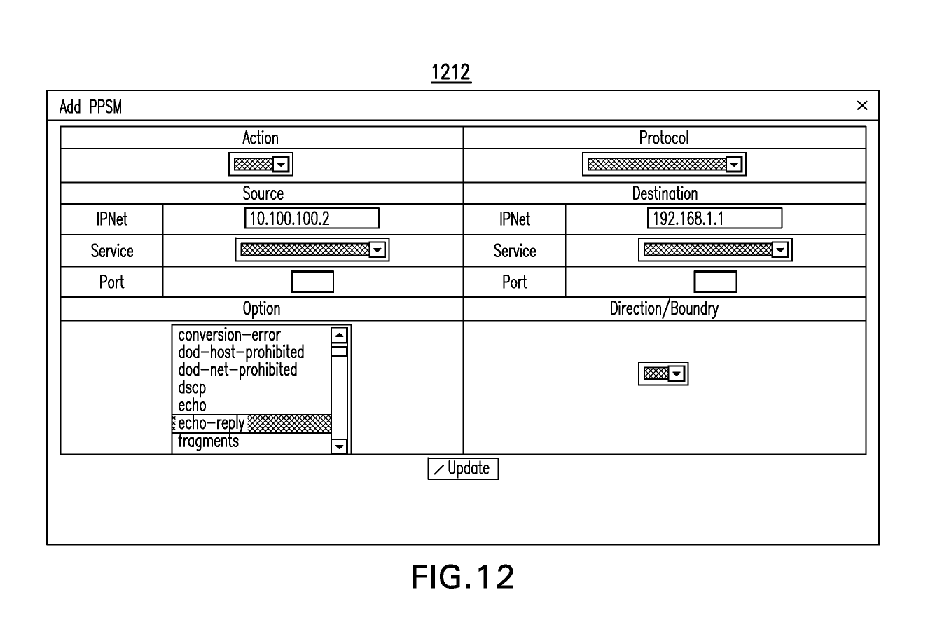

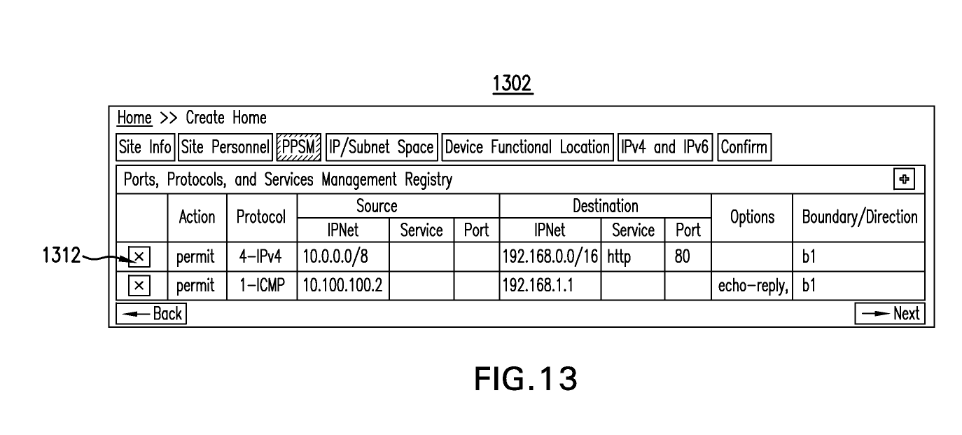

One of the fundamental aspects of the DIACAP processes is the implementation of the PPSM registry. Sites should have an approved PPSM in place that documents the requirements of operational traffic flows. A user may enter PPSM data by selecting plus sign button 1112 on the upper right of PPSM tab 816 thereby causing an Add PPSM window 1212 to open, as shown in FIG. 12, that allows a user enter data based off of a sites PPSM registered document. Once has entered PPSM info for the appropriate sites as shown in FIG. 13, if the user finds a mistake, the user can select an x-button 1312 to the left of the errant PPSM entry. The user can then re-enter the data as necessary.

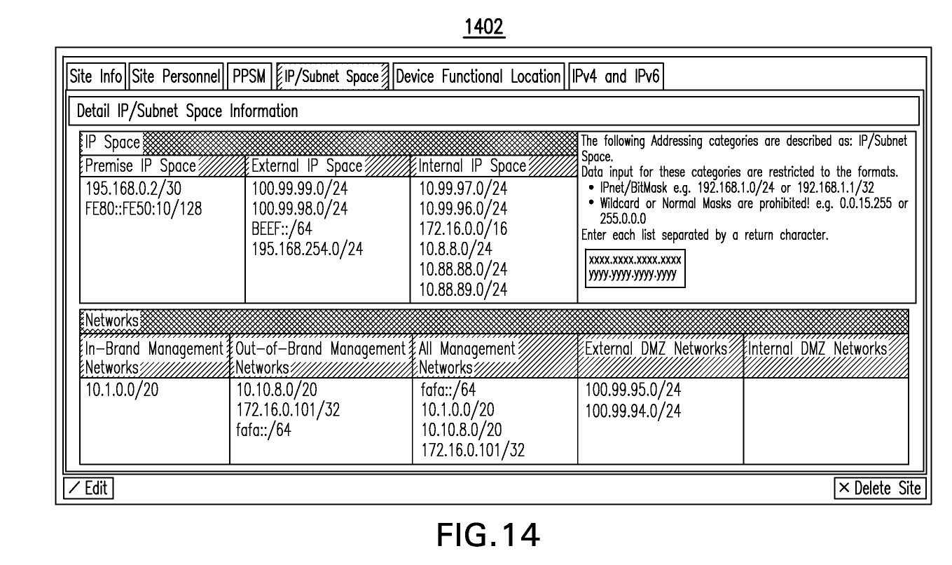

Selecting Next button 1362 or directly selecting IP/Subnet Space tab 818 opens IP/Subnet Space page 1402 shown in FIG. 14.

IP/Subnet Space page 1402 shows Site Specific IP subnets and LANs organized according to functional location as seen in FIG. 14. Descriptions of these subnets and LANs are provided below.

Premise (PoP—Point of Presence): The IPs in this subnet(s) or VLANs are technically owned by the ISP (Internet Service Provider) or Circuit provider and NOT under the ‘Sites’ authority. However, it is required to identify this subnet for analysis purposes.

External: The IPs in this subnet(s) or VLANs are under the “Sites” administrative authority. They are registered internet routable IPs and while restricted, are designated as publicly accessible. Their function should be clearly defined as external.

Internal: The IPs in this subnet(s) or VLANs are under the “Sites” administrative authority. They can either be registered internet routable IPs or RFC 1918 designated private IP spaces. If they are registered internet routable IPs they are usually designated as internal if restricted access from external sources via approved Department of Defense (DoD) firewalls or proxy services at a boundary I. Their function should be clearly defined as internal.

In-band Management: The IPs in this subnet(s) or VLANs are under the “Sites” administrative authority. The in-band management IP spaces are technically Internal IPs that are specially designated for Management purposes. The IPs also utilize the same physical architecture as the operational environment only being separated on a logical basis. Their function should be clearly defined as In-band management.

Out-of-band Management: The IPs in this subnet(s) or VLANs are under the “Sites” administrative authority. The out-of-band management (Oobm) IP spaces are technically Internal IPs that are specially designated for Management purposes. However, the IPs do not share the same physical architecture as the operational environment and utilize a separate designated OOBM specific hardware for its management purposes. Their function should be clearly defined as out-of-band management.

All Management: The IPs in this subnet(s) or VLANs comprise of both In-band and Out-of-band Management IP spaces. NOTE: If any of the above specified management IP spaces are defined for a site, this section MUST contain each set of IP spaces. This may seem redundant but this is necessary due to certain STIG checks that do not make a distinction between the two types of Management spaces and as a result, this section provides the means to analyze those checks that do not explicitly define the “type” of management space to check for.

External DMZ: The IPs in this subnet(s) or VLANs are under the ‘sites’ administrative authority. The External DMZ IP spaces are technically External IP's that are specially designated for DMZ type purposes. Their function should be clearly defined as External DMZ.

Internal DMZ: The IP's in this subnet(s) or VLANs are under the ‘sites’ administrative authority. The Internal DMZ IP spaces are technically Internal IPs that are specially designated for DMZ type purposes. Their function should be clearly defined as Internal DMZ.

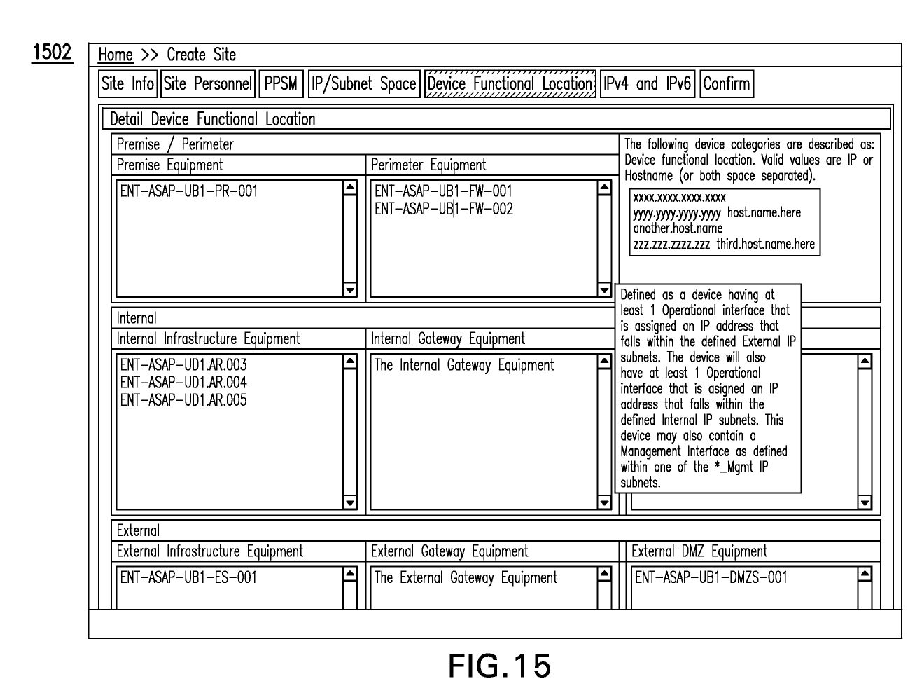

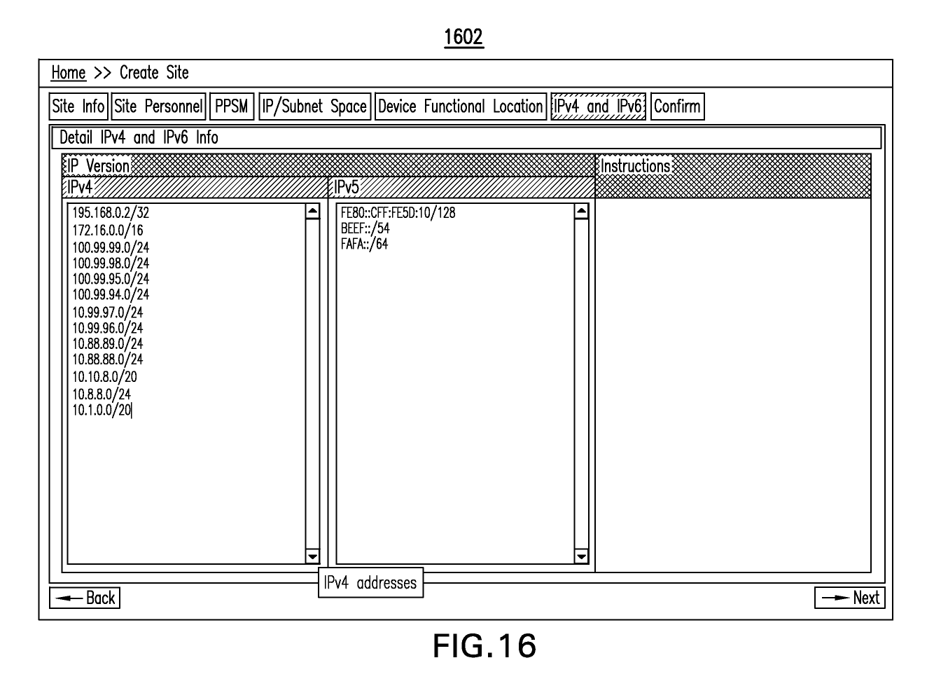

FIG. 15 shows Device Functional Location page 1502 accessed by selecting Device Functional Location tab 820. Device Functional Location page 1502 allows a user to enter hostname• or Management IP specific devices within their respective functional locations. As specified in IP/Subnet Space page 1402, each category is based upon industry best practices. You can click on the whitespace within a category box and review the definitions that are attributed to each category. Device Functional Location tab 820 is designed to help organize site devices according to their functional locations.

FIG. 15 shows IPv4 and IPv6 page 1602 that is accessed by selecting IPv4 and IPv6 tab 822. For tracking purposes, a user can document a complete set of IPv4 and IPv6 subnets/vlans for a site. IPv4 and IPv6 page 1602 may be used to organize a site's complete listing of IP subnets/LANs. The analysis engine of the compliant reporting tool utilizes the listing of IP subnets on IPv4 and IPv6 page 1602 to make a determination of what IPs are managed/owned by the site. IPv4 and IPv6 page 1602 can include information for all IP categories, i.e. Internal, External, DMZ, etc. One purpose of IPv4 and IPv6 page 1602 is to distinctly separate a site's administratively owned IP space from all others.

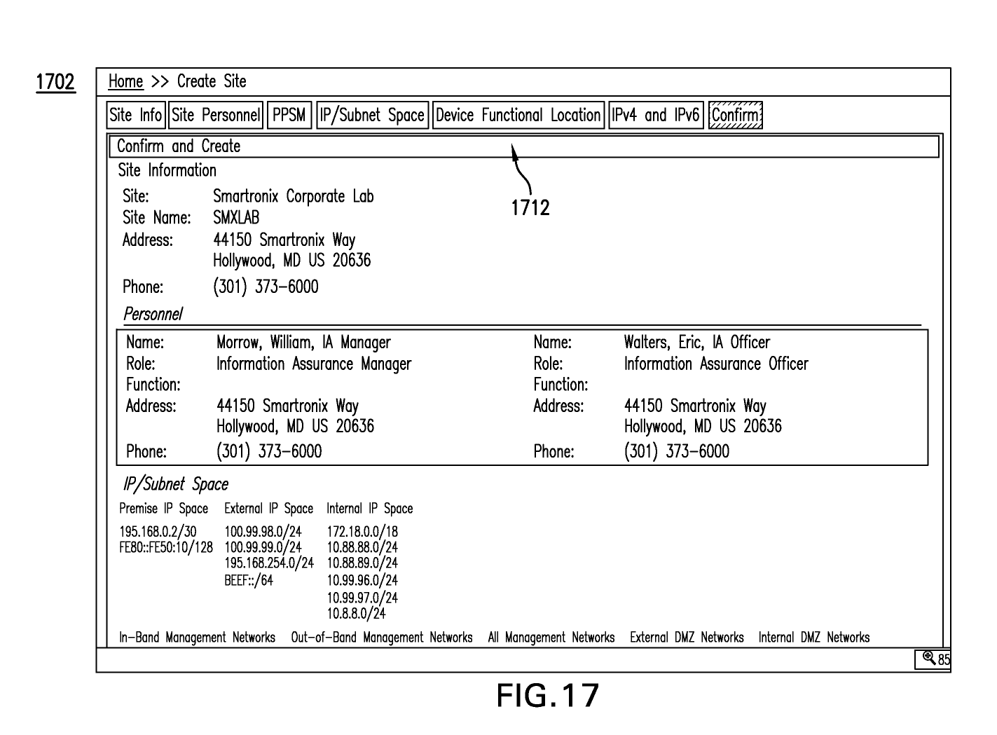

FIG. 17 shows Confirm page 1702 that is accessed by selecting Confirm tab 824. Once completed with all the “Site’ specific information, Confirm page 1702 allows a user to review the data that has been entered, and, after checking for accuracy, and select Confirm and Create button 1712.

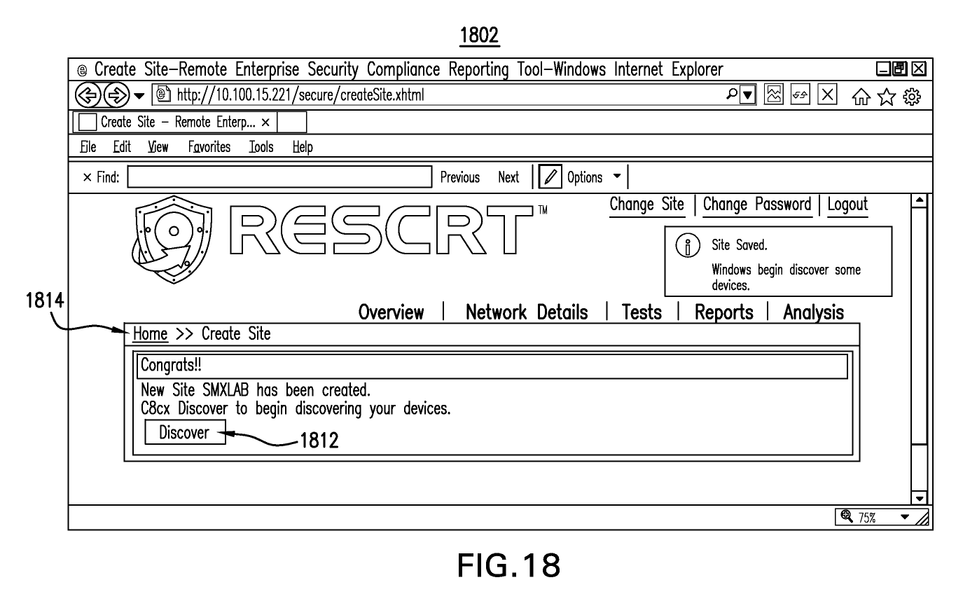

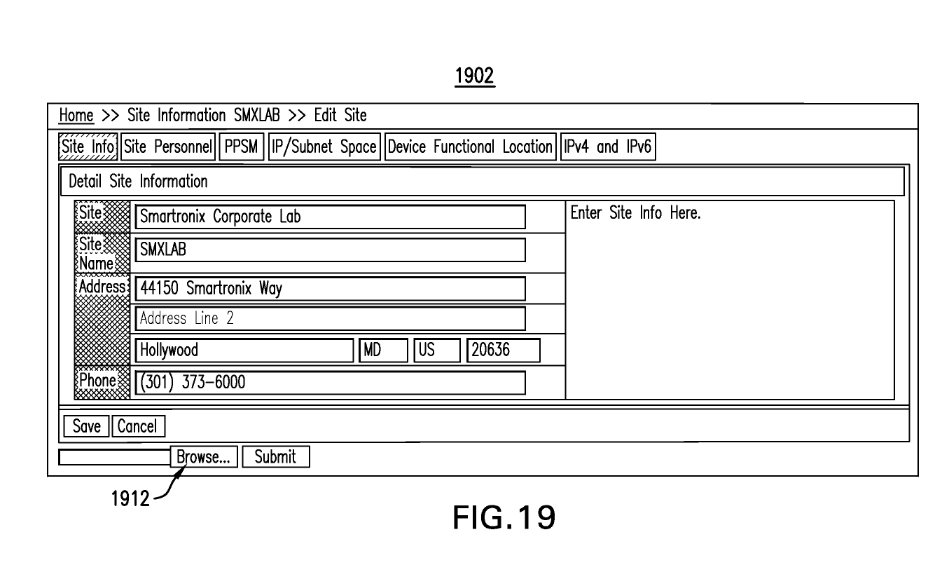

Selecting Confirm and Create button 1712 causes a page 1802 displaying a Discover button 1812 to be shown to the user as shown in FIG. 18. The user may select Discover button 1812 to go directly to Discover Devices page 304, or the user can select a home link 1814 to take the user back to home page 702.

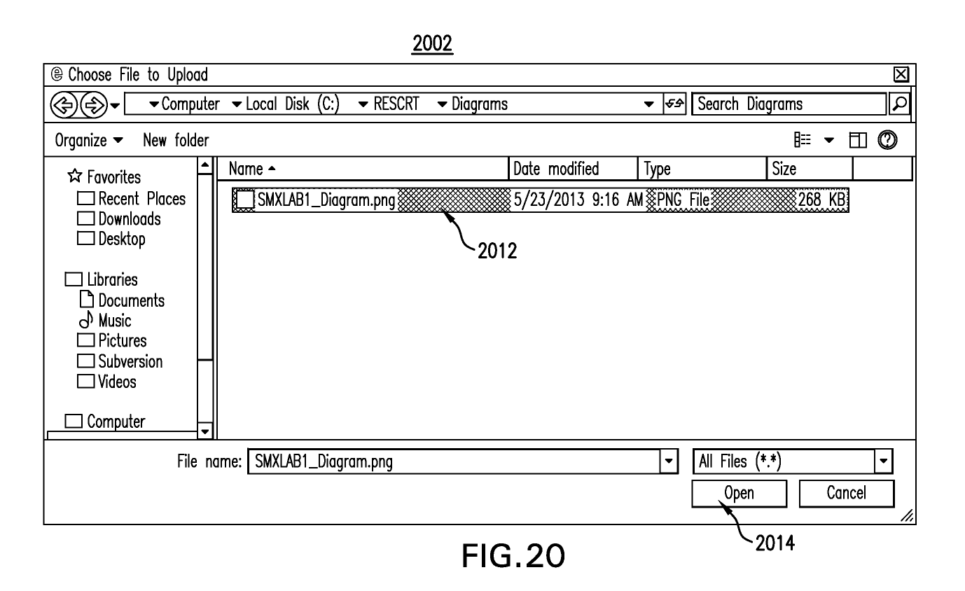

Once a user has created a site, a user can go back to the Info link 724 of Main menu 722 of home page 702 to re-enter or edit site specific info if changes are required. A user also has the ability to now upload a “site” diagram that can provide as a visual reference for the site. A user selects Info link 724 and a Site Info page (not shown) is displayed to a user. A user clicks on an edit button the Site Info page and an Edit Site Info 1902 appears. The user selects browse button 1912 and window 2002 appears as shown in FIG. 20.

A user can then navigate window 2002 and select a site diagram 2012. Selecting site diagram 2012 and selecting Open button 2014 cause site diagram 2012 to display at the bottom half of the Site Info pages (not shown in FIG. 20) for easy visual reference to the site.

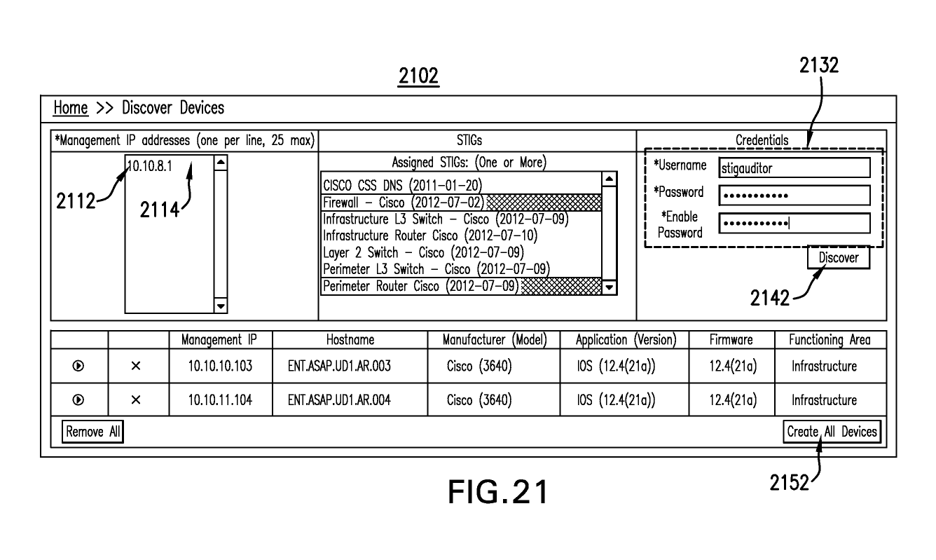

The next step after creating a site is to begin adding devices to the database. From Home page 702 a user selects Discover Network Devices link 730 causing Discover Devices page 2102 to display as shown in FIG. 21. A user adds primary Management IP address 2112 on in entry space 2114. The user selects an appropriate base STIG 2122 the device types. The user then enters device credentials 2132 and selects Discover button 2142.

An efficient way to discover devices is by grouping them according to their base STIG, prior to performing the discovery. For example, if a user has 10 Layer 3 Infrastructure switches and 5 perimeter routers, enter the 10 Infrastructure devices, populate the credentials accordingly and select on the Discover button 2142. Once the records are populated at the bottom of the page you can then perform discovery against the 5 perimeter routers. When a user believes that the user has discovered all of the relevant devices the user wants to enter into the database, the user selects Create All Devices button 2152. This procedure will populate the database for this particular site and will now allow the user to begin creating test plans against those devices.

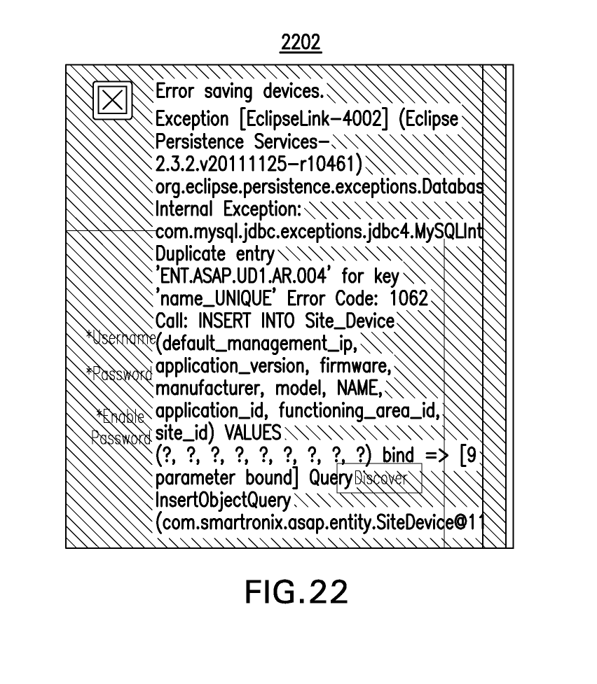

The database is designed to accept only one instance of a device regardless of site. If you have multiple sites and somehow this device bridges both sites, only one site is allowed to contain that device. Attempting to re-discover the same device for a different site will result in an error for duplicate entries and the displaying of a pop-up error window, such as pop-up error window 2202 shown in FIG. 22.

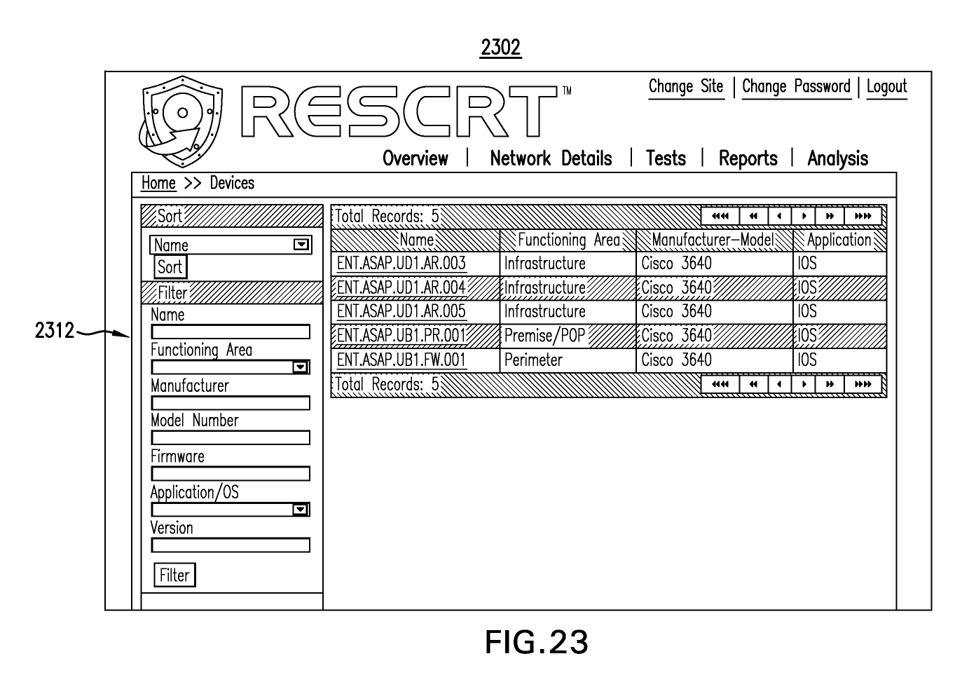

Once a user has completed the discovery and creation of devices into the database, a user can review the list of devices by going to Main menu 722 on home page 702 and selecting All Devices link 728, causing All devices summary page 2302 to display as shown in FIG. 23. A Device menu 2312 includes options such as sorting the following header values, Name, Functioning Area, Manufacturer, Model Number, Firmware, Application/OS and Version, Manufacturer-Model, and Application. Filtering options are also available to only display the devices according to the filter.

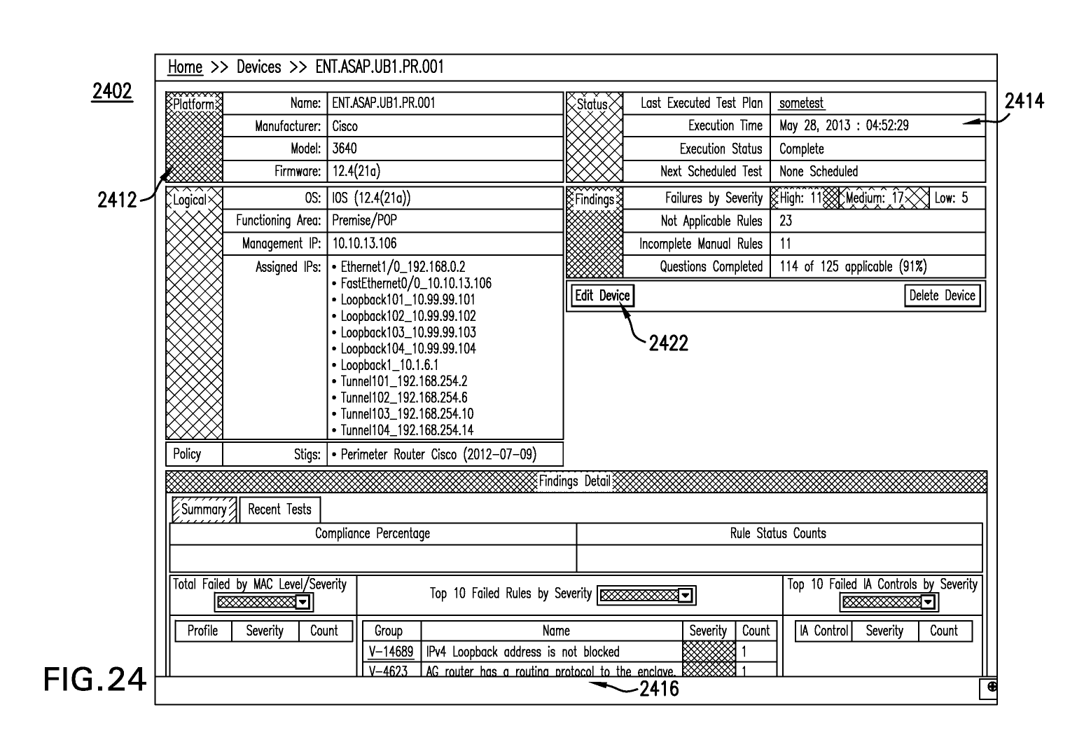

A user can select a device name to drill down into detailed specifics for a device. In one embodiment, the compliance reporting tool of the present invention is designed to collect as much relevant data as necessary for both system owners as well as validators to be able to perform their roles with as much efficiency and accuracy as possible. FIG. 24 shows a Device page 2402.

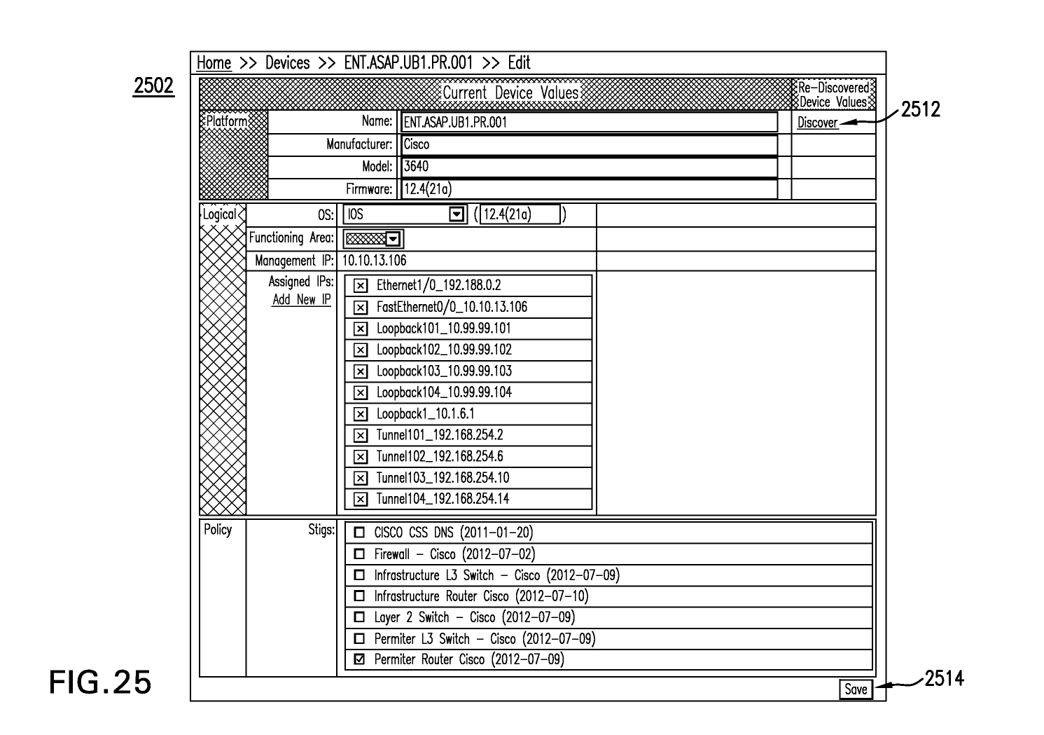

An Upper left section 2412 of Device page 2402 contains device specific information. An upper right section 2414 of Device page 2402 contains historical data based upon test plan analysis and the role up of the latest findings. A bottom half 2416 of Device page 2402 provides further details based upon the test plan results. Each section is specifically designed to allow system owners and/or validators the ability to manage a device status in the context of C&A processes. If device specific data is found to be incorrect or outdated, a user can select Edit device button 2422 to open Edit page 2502 shown in FIG. 25.

Edit page 2502 allows a system owner or validator the ability to manually modify devices specific information as necessary. Although the compliance reporting tool of this example automates the entry of device information for a user, there are always cases in which manual correction may be required. Also, if there is outdated information and a user wishes to “refresh” the device specific info, a user can select Discover link 2512. This will bring up a “Login” credentials popup (not shown in FIG. 25), allowing a user to perform a rediscovery of the device to update its values, within the database. If changes are made and everything is accurate, the user can click on Save button 2514 to save the information.

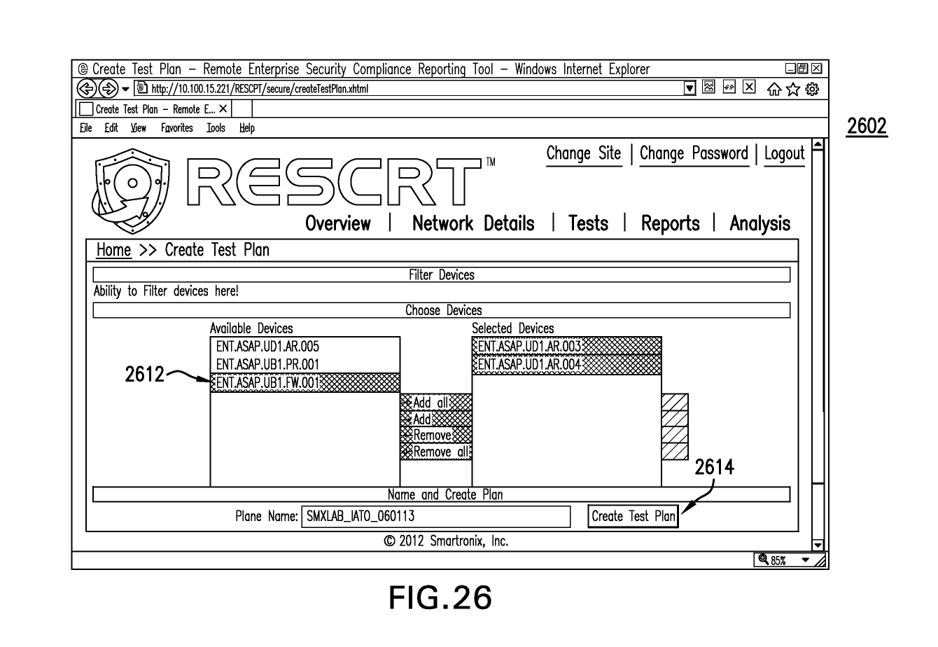

Once a user has confirmed the network devices have been entered into the database and are ready to begin Analysis, the user can return to home page 702. The user then selects Create a New Test Plan link 734 and Create a New Test Plan page 2602 will be displayed as shown in FIG. 26.

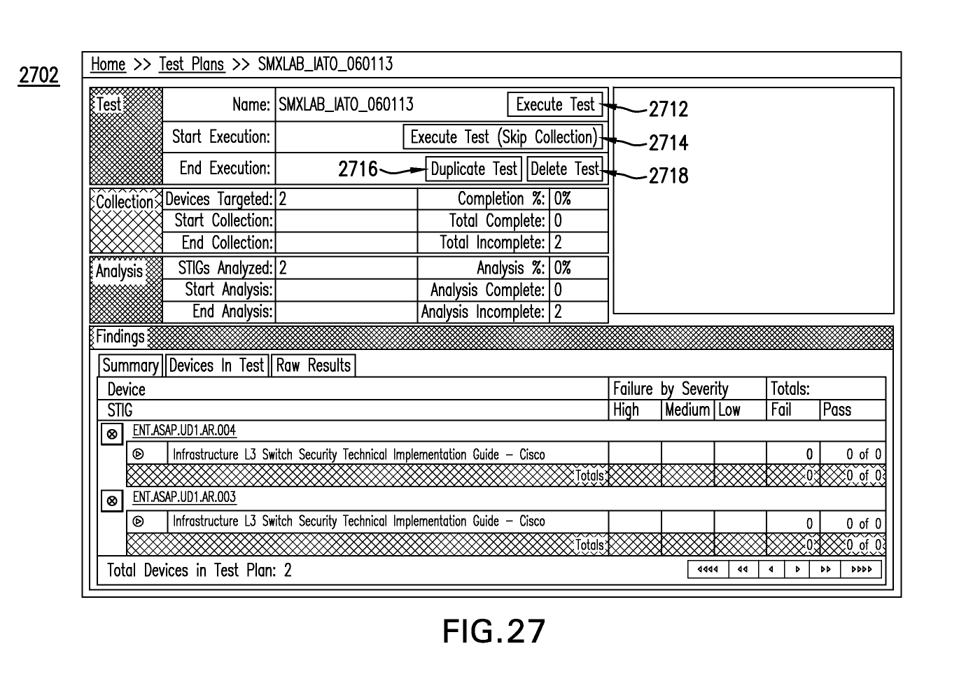

The user then highlights the devices the user wishes to analyze in left column 2612 and selects an Add button (not shown in FIG. 26. This will populate the right column. Once the users selected all of the devices the user wishes to analyze, the user types in a meaningful test plan name and selects Create Test Plan button 2614 and a Test Plan page 2702 is displayed as shown in FIG. 27.

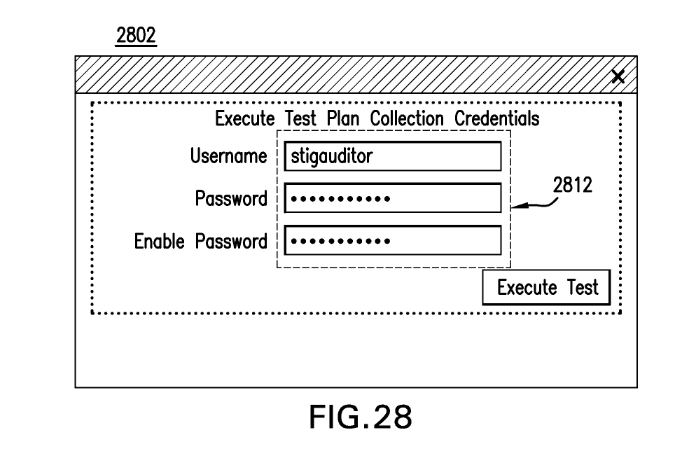

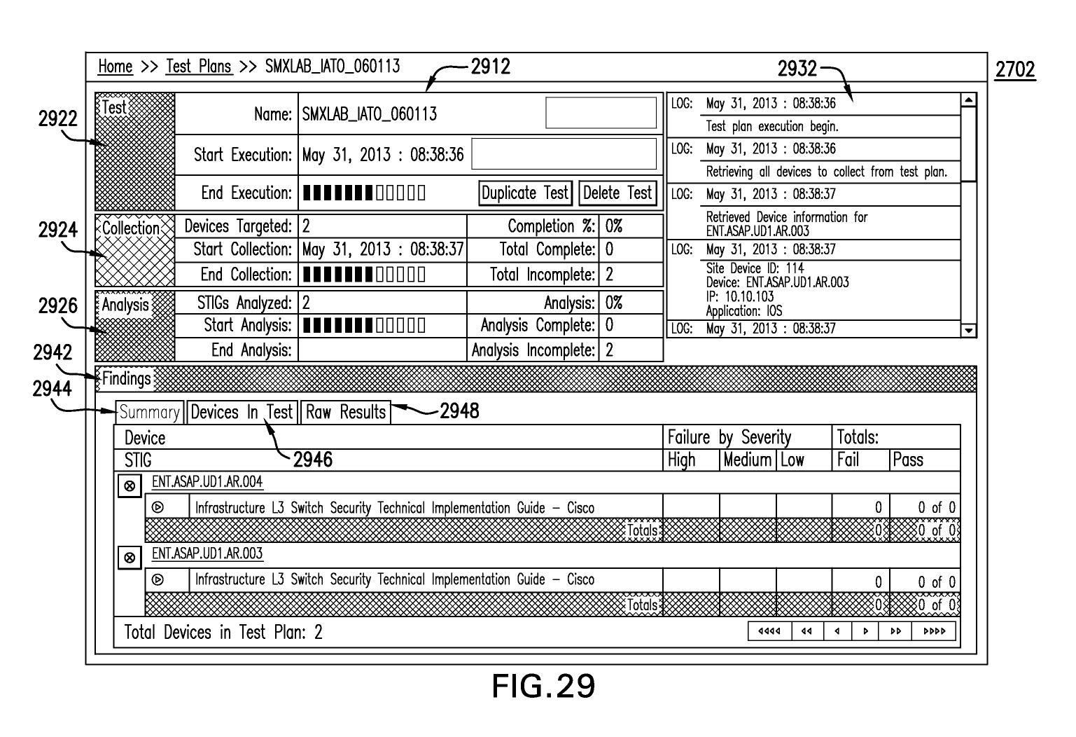

Test Plan page 2702 includes an Execute Test button 2712, an Execute Test (Skip Collection) button 2714, a Duplicate Test button 2716, and a Delete Test button 2718. When a user selects Execute Test button 2712, a device credential pop-up window 2802 appears as shown in FIG. 28. The user enter appropriate credentials 2812 and then selects Execute Test button 2814 causing Test Plan page 2702 to appear as shown in FIG. 29.

As can be seen on Test Plan page 2702 as shown in FIG. 29, the compliance reporting tool of this example has begun to execute a series of Test Plan functions. Top section 2912 of Test Plan page 2702 allows the user to monitor what is happening during this Test Plan execution phase. Test box 2922 monitors the overall Test Plan progress from Start to Finish. Collection box 2924 monitors the overall progress for collecting device data. Analysis box 2926 monitors the overall progress for analyzing each device. Upper right corner 2932 is reserved for logging and error reporting for each function (color coded to match the functions on the left.) In the event of a misfire, the user can analyze the log entries to determine where the functional errors occurred.

Findings section 2942 is made up of 3 tabs: Summary tab 2944, Devices in Test tab 2946, and Raw Results tab 2948. In FIG. 29, Devices in Test tab 2946 has been selected by the user causing Test Plan page 2902 to display the detailed analysis per STIG/per device. When selected, Summary tab 2944 displays graphical Top Category charts for reporting and rollup analysis. When selected, Raw Results tab displays the combined raw results of the test plan and this is where you can also, export a CSV file containing the results data for post processing.

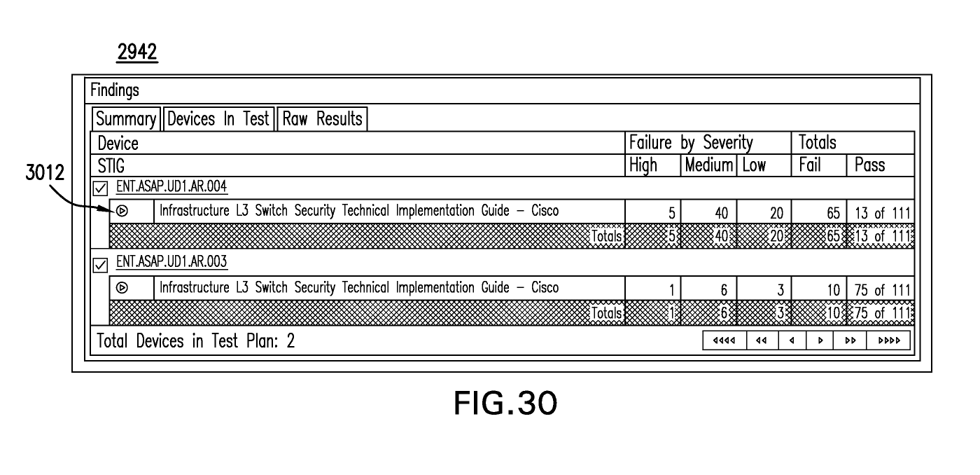

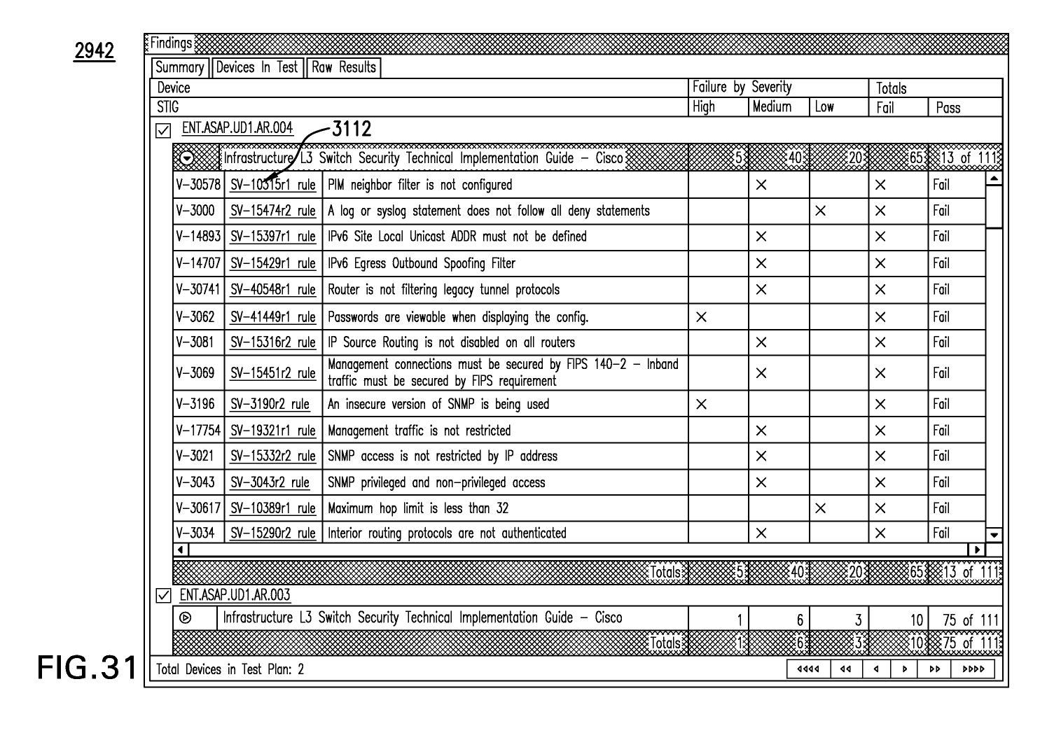

When the Test Plan completes successfully, Findings section 2942 of Test Plan Page 2702 shows the results of the analysis for each device as shown in FIG. 30. A user can select triangle button 3012 on the left of each device to expand the full listing of the results of the STIG analysis. Such a full listing is shown in FIG. 31.

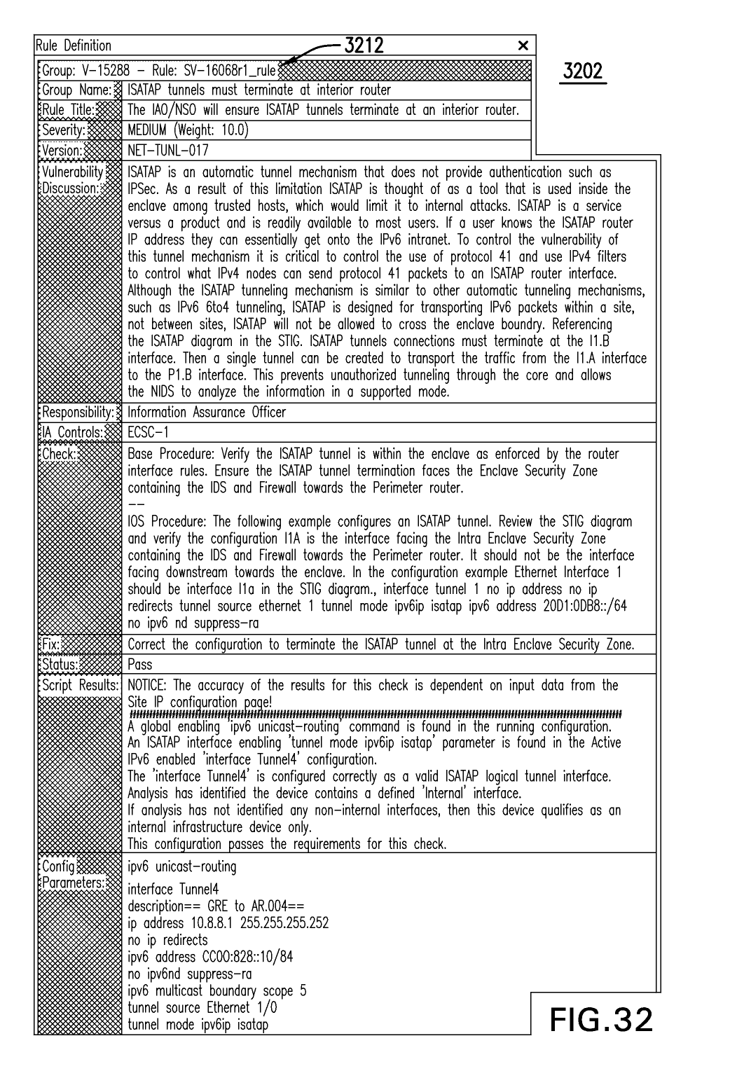

FIG. 31 shows a listing of each STIG rule check and the results of the analysis, per device. A user can select a rule link 3112 to display a window 3202 detailed analysis and results for a particular STIG as shown in FIG. 32. Each field in table 3212 of window 3202 is derived completely from the native STIG XCCDF policy document so there is no question as to the source of the policy verbiage.

The following additional fields are added to table 3212 post analysis for review: Status: Pass, Fail, Not Applicable or Manual; Script Results: This section provides the user with itemized results based upon the configuration findings of the device; and Configuration Parameters: This section provides the user with the relevant configuration data supporting the Script Results analysis.

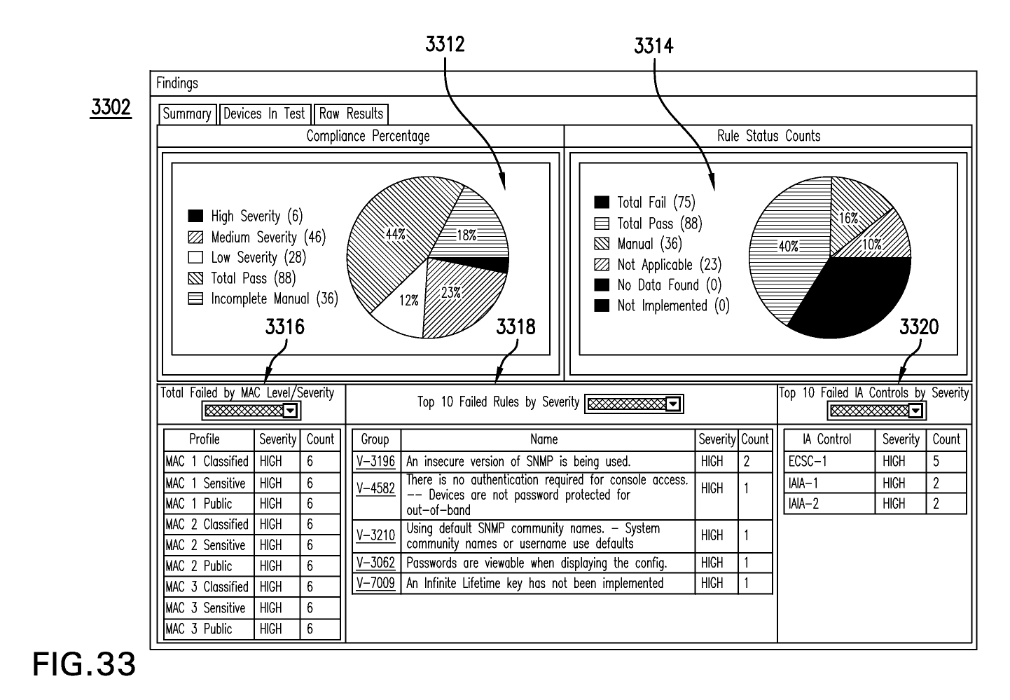

FIG. 33 shows a Summary window 3302 accessed by selecting Summary Tab 2944 in Findings section 2942. Summary window 3302 displays a Compliance Percentage chart 3312, a Rule Status Counts chart 3314, a Total Failed by MAC Level/Severity chart 3316, a Top 10 Failed Rules by Severity chart 3318 and a Top 10 Failed IA Controls by Severity chart 3320. Compliance Percentage chart 3312 is a pie chart based upon the Test plan's combined raw data on Pass/Fail The Fail slices are divided by severity, High, Medium, and Low. Rule Status Counts chart 3314 is a pie chart based upon the Test plans combined raw data on the individual results, including Not Applicable and if they exist, STIGS with missing results. Total Failed by MAC Level/Severity chart 3316 is a list chart based upon the Test plans combined raw data. This column can be filtered to display total failures by severity according to its MAC level. Top 10 Failed Rules by Severity chart 3318 is a list chart based upon the Test plans combined raw data. This column displays the Top 10 Failed individual Group ID number/Rule by severity. Top 10 Failed IA controls by Severity chart 3320 is a list chart based upon the Test plans combined raw data. This column displays the Top 10 Failed IA controls by severity.

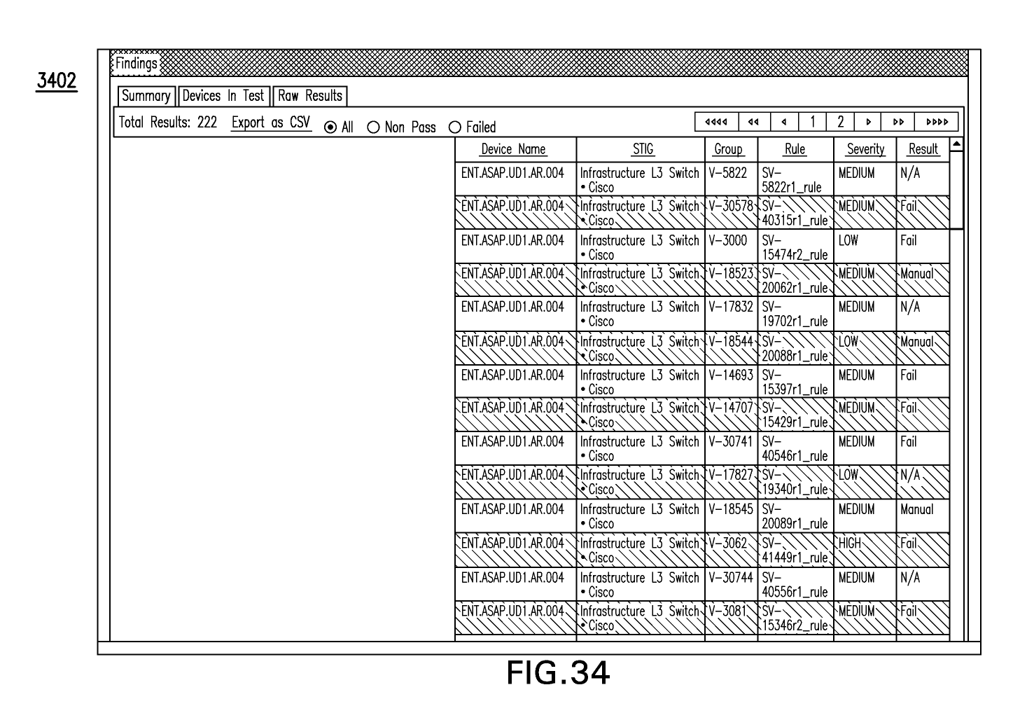

FIG. 34 shows a Raw Results window 3402 accessed by selecting Raw Results tab 2948 in Findings section 2942. Raw Results window 3402 is the combined listing of each STIG results per device per STIG document, etc. Raw Results window 3402 is also where a user can perform an export of a CSV formatted spreadsheet for the raw data for further post processing and reporting. A user can filter your export selection based on ALL, Non Pass, or Failed raw data.

In recent years, the C&A environment has undergone a very positive change towards the direction of standardizing security compliance and automation tools for policies such as the DIACAP. NIST (National Institute of Standards and Technologies) in collaboration with the overall security and C&A community has developed the SCAP (Security Content Automation Protocols) standards. The SCAP standards provide a framework in which Security Content and the applications that process them for the purpose of viewing and reporting must adhere to a standard definition, XCCDF (Extensible Configuration Checklist Description Format). Therefore, a goal of the compliance reporting tool according to one embodiment of the present invention is to ensure that viewing and reportable content is exportable and cross-platform so as to be able to go from one SCAP certified application to another for processing. It is important that the final reportable content is an SCAP-compliant, XML-based format.

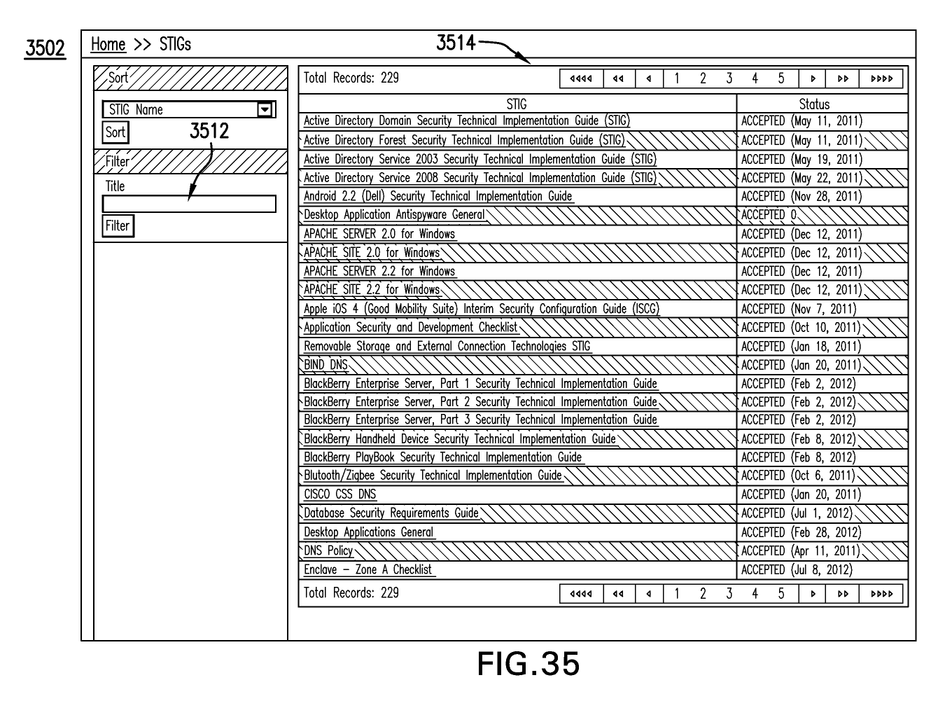

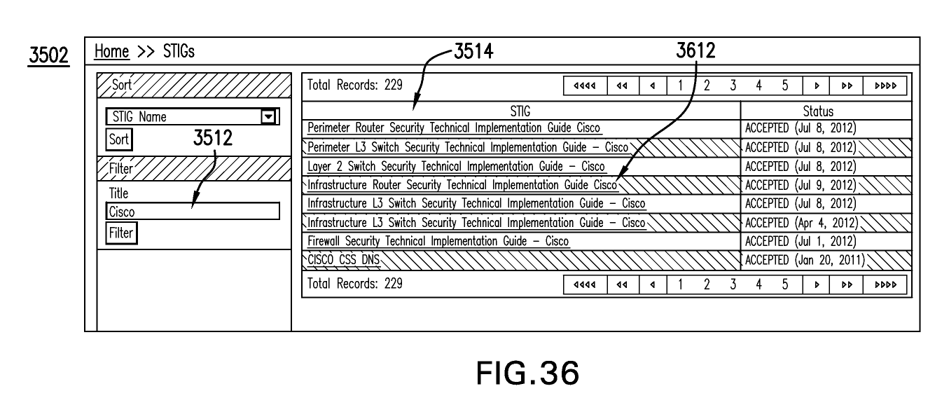

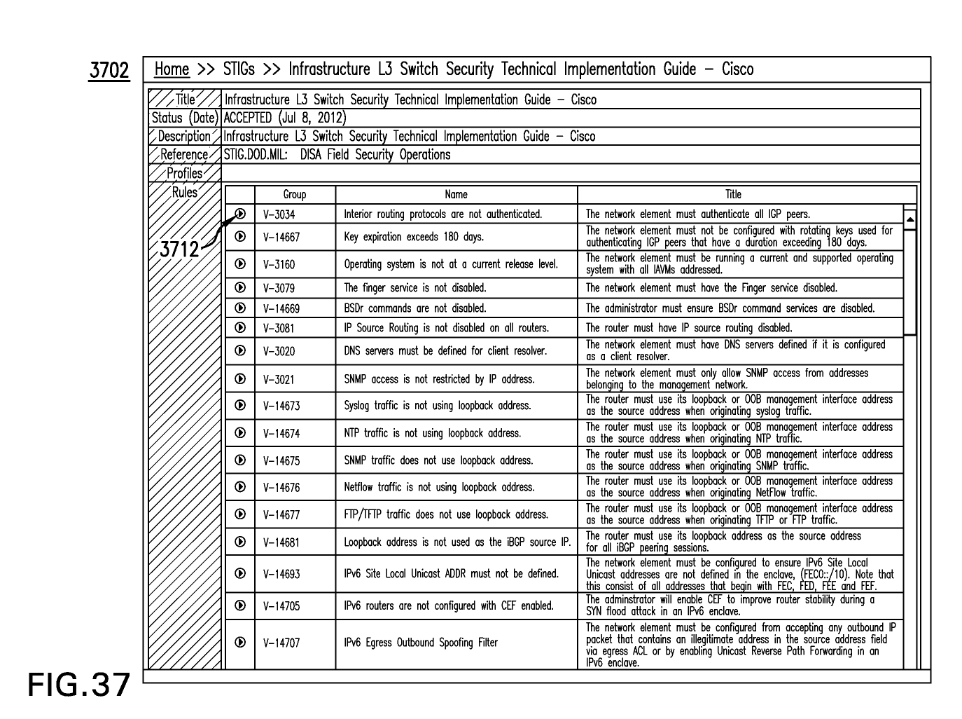

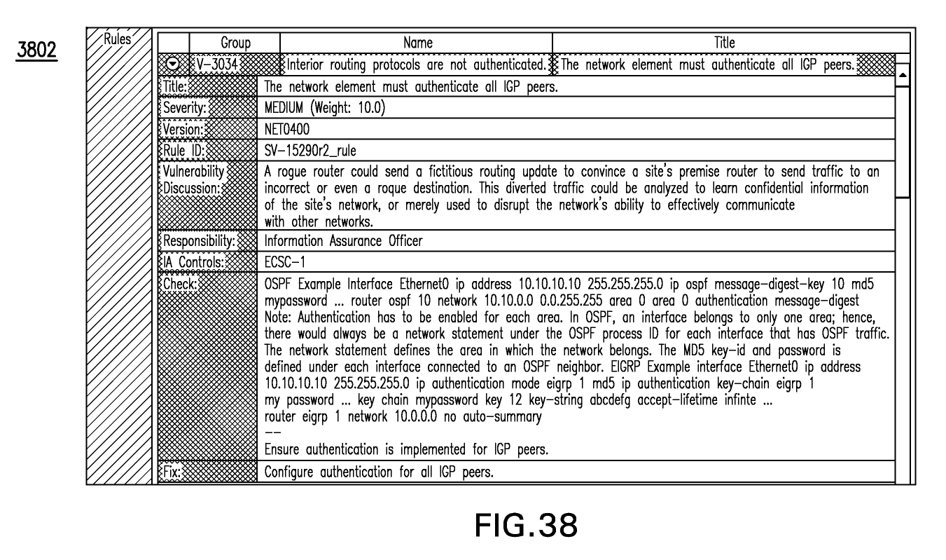

By selecting All STIGs link 736 on Main menu 722 on home page 702, All STIGs page 3502 to display as shown in FIG. 35. Under a Filter′ (search) section 3512 a user can you can type in a key word and viewer 3514 display STIGs with names containing those key words as shown in FIG. 36. By selecting a document 3612 in viewer 3514, a window 3702 is displayed to the user. By selecting a triangle button 3712 to the left of a STIG V-ID rule, a window 3802 is displayed showing detail information as shown in FIG. 38.

### Example 2

A compliance recording tool according to one embodiment of the present invention is used to check the compliance of Brocade devices. The compliance recording tool interacts with other subcomponents via APIs and had capabilities to share results upstream or consume reports from downstream. The compliance recording tool includes a base platform, a User Interface (UI) for users to schedule tests and view reports or test outputs, an administration interface for user maintenance and maintenance of the compliance reporting tool, and dashboards for reporting results. A server hosts all logic and clients used web browsers to interact with server.

The datastore for the compliance recording tool is a repository for all tests completed, was Query-able by reporting engine and the base platform, is written to by the base platform, provides storage for device configurations collected, is where test logic (scripted language scripts, such as Pert scripts) are stored.

Testing modules allow users to schedule tests via the base platform, which fetch the configuration testing information from the appropriate testing module. Testing modules would look for newest configuration testing specifications for modules the platform has licenses for (e.g. Cisco, Juniper, Brocade, etc.). The testing module fetches new configurations and store them in the datastore. The testing module provides configurations to the base platform when asked (if the license is there and the configuration file is there). License key checking/management was done to ensure customers have licenses for the modules they are using}

A reporting engine includes an interface hosted in the base platform to generate the suite of reports including graphs, information on current status, information on trending, etc.

### Examples 3-17

In one embodiment of the present invention, given a policy, set of policies, or policy checks, that must be enumerated against a given system, system component or system IT asset, one or more system-related associative and/or non-associative entities are defined. Programming logic is used to cross-reference the one or more defined entities against the system, system component or system IT Asset configuration, to validate applicability, non-applicability and compliance or non-compliance of the policy, set of policies, or policy checks.

In one embodiment of the present invention, pre-defined entities are established in regards to the methods used by a compliance reporting tool of the present invention. The pre-defined entities combine to offer a framework that allows for the contextual awareness required to define a given system. Utilizing such a framework, users of the compliance reporting tool of the present invention have the unique ability to cross-reference an entity or entities against the system, system component or system IT asset to enumerate a given policy.

The types of entities described in Examples 3-17 below are not all inclusive but are representative of the type of entities that may be used for a standard IT systems network architecture. In one embodiment of the present invention various types of user-defined entities may be created so long as the user-defined entities provide usefulness to the enumeration of the policy, set of policies, or policy checks.

### Example 3

One or more management entities are defined by populating the one or more management entities with objects associated with or relevant to a “management zone.” Examples of objects associated with or relevant to a “management zone” my include: an IP address, subnet, network, VLAN, serial number, hostnames, MAC address, account name, policy, documentation, or some user-defined object meeting the systems management-related criteria such as a management IP subnets entity containing management-related IPs. Given a policy, set of policies, or policy checks, that must be enumerated against a given system, system component or system IT asset that also requires the use of this management-related criteria, i.e. management context, programming logic is used to cross-reference the defined one or more management entities against the system configuration, system component configuration and/or system IT asset configuration to validate applicability, non-applicability and compliance or non-compliance of the policy, set of policies, or policy checks. The results of cross-referencing the one or more management entities against the system configuration, system component configuration and/or system IT asset configuration are then displayed to a user on a visual display device and/or saved to a storage medium.

### Example 4

One or more internal entities are defined by populating the one or more internal entities with objects associated with or relevant to an “internal zone.” Examples of objects associated with or relevant to an “internal zone” may include: IP address\subnet\network, VLAN, serial number, hostnames, MAC address, account name, policy, documentation, or some user-defined object meeting the systems internal-related criteria such as an internal IP subnets entity containing internal-related IPs. Given a policy, set of policies, or policy checks, that must be enumerated against a given system, system component or system IT asset that also requires the use of this internal-related criteria, i.e. internal context, programming logic is used to cross-reference the defined one or more internal entities against the system configuration, system component configuration and/or system IT asset configuration to validate applicability, non-applicability and compliance or non-compliance of the policy, set of policies, or policy checks. The results of cross-referencing the one or more internal entities against the system configuration, system component configuration and/or system IT asset configuration are then displayed to a user on a visual display device and/or saved to a storage medium.

### Example 5

One or more external entities are defined by populating the one or more external entities with objects associated with or relevant to an “external zone.” Examples of objects associated with or relevant to an “external zone” may include: an IP address\subnet\network, VLAN, serial number, hostnames, MAC address, account name, policy, documentation, or some user-defined object meeting the systems external-related criteria such as an external IP subnets entity containing external-related IPs. Given a policy, set of policies, or policy checks, that must be enumerated against a given system, system component or system IT asset that also requires the use of this external-related criteria, i.e. external context, programming logic is used to cross-reference the defined one or more external entities against the system configuration, system component configuration and/or system IT asset configuration to validate applicability, non-applicability and compliance or non-compliance of the policy, set of policies, or policy checks. The results of cross-referencing the one or more external entities against the system configuration, system component configuration and/or system IT asset configuration are then displayed to a user on a visual display device and/or saved to a storage medium.

### Example 6

One or more premise entities are defined by populating the one or more premise entities with objects associated with or relevant to a “premise zone.” Examples of objects associated with or relevant to an “premise zone” may include: an IP address\subnet\network, VLAN, serial number, hostnames, MAC address, account name, policy, documentation, or some user-defined object meeting the systems premise-related criteria such as a premise IP subnets entity containing premise-related IPs. Given a policy, set of policies, or policy checks, that must be enumerated against a given system, system component or system IT asset that also requires the use of this premise-related criteria, i.e. premise context, programming logic is used to cross-reference the defined one or more premise entities against the system configuration, system component configuration and/or system IT asset configuration to validate applicability, non-applicability and compliance or non-compliance of the policy, set of policies, or policy checks. The results of cross-referencing the one or more premise entities against the system configuration, system component configuration and/or system IT asset configuration are then displayed to a user on a visual display device and/or saved to a storage medium.

### Example 7

One or more DMZ entities are defined by populating the one or more DMZ entities with objects associated with or relevant to a “DMZ zone.” Examples of objects associated with or relevant to an “DMZ zone” may include: an IP address\subnet\network, VLAN, serial number, hostnames, MAC address, account name, policy, documentation, or some user-defined object meeting the systems DMZ-related criteria such as a DMZ IP subnets entity containing DMZ-related IPs. Given a policy, set of policies, or policy checks, that must be enumerated against a given system, system component or system IT asset that also requires the use of this DMZ-related criteria, i.e. DMZ context, programming logic is used to cross-reference the defined one or more DMZ entities against the system configuration, system component configuration and/or system IT asset configuration to validate applicability, non-applicability and compliance or non-compliance of the policy, set of policies, or policy checks. The results of cross-referencing the one or more DMZ entities against the system configuration, system component configuration and/or system IT asset configuration are then displayed to a user on a visual display device and/or saved to a storage medium.

### Example 8

One or more server entities are defined by populating the one or more server entities with objects associated with or relevant to a “server zone.” Examples of objects associated with or relevant to an “server zone” may include: an IP address\subnet\network, VLAN, serial number, hostnames, MAC address, account name, policy, documentation, or some user-defined object meeting the systems server-related criteria such as a server IP subnets entity containing server-related IPs. Given a policy, set of policies, or policy checks, that must be enumerated against a given system, system component or system IT asset that also requires the use of this server-related criteria, i.e. server context, programming logic is used to cross-reference the defined one or more server entities against the system configuration, system component configuration and/or system IT asset configuration to validate applicability, non-applicability and compliance or non-compliance of the policy, set of policies, or policy checks. The results of cross-referencing the one or more server entities against the system configuration, system component configuration and/or system IT asset configuration are then displayed to a user on a visual display device and/or saved to a storage medium.

### Example 9

One or more accounts entities are defined by populating the one or more accounts entities with objects associated with or relevant to “accounts.” Examples of objects associated with or relevant to “accounts” may include: an IP address\subnet\network, VLAN, serial number, hostnames, MAC address, account name, policy, documentation, or some user-defined object meeting the systems accounts-related criteria such as a validated accounts entity containing account-related objects such as names and account-related policies. Given a policy, set of policies, or policy checks, that must be enumerated against a given system, system component or system IT asset that also requires the use of this accounts-related criteria, i.e. accounts context, programming logic is used to cross-reference the defined one or more accounts entities against the system configuration, system component configuration and/or system IT asset configuration to validate applicability, non-applicability and compliance or non-compliance of the policy, set of policies, or policy checks. The results of cross-referencing the one or more accounts entities against the system configuration, system component configuration and/or system IT asset configuration are then displayed to a user on a visual display device and/or saved to a storage medium.

### Example 10

One or more software entities are defined by populating the one or more software entities with objects associated with or relevant to “software.” Examples of objects associated with or relevant to “software” may include: an IP address\subnet\network, VLAN, serial number, hostnames, MAC address, account name, policy, documentation, or some user-defined object meeting the systems software-related criteria such as a validated software versions entity containing software objects such as manufacturer, versions, and software-related policies. Given a policy, set of policies, or policy checks, that must be enumerated against a given system, system component or system IT asset that also requires the use of this software-related criteria, i.e. software context, programming logic is used to cross-reference the defined one or more software entities against the system configuration, system component configuration and/or system IT asset configuration to validate applicability, non-applicability and compliance or non-compliance of the policy, set of policies, or policy checks. The results of the cross-referencing the one or more software entities against the system configuration, system component configuration and/or system IT asset configuration are then displayed to a user on a visual display device. The results of cross-referencing the one or more software entities against the system configuration, system component configuration and/or system IT asset configuration are then displayed to a user on a visual display device and/or saved to a storage medium.

### Example 11

One or more policy entities are defined by populating the one or more policy entities with objects associated with or relevant to a “policy.” Examples of objects associated with or relevant to a “policy” may include: IP address\subnet\network, VLAN, serial number, hostnames, MAC address, account name, policy, documentation, or some user-defined object meeting the systems policy-related criteria such as a policy exceptions entity containing policy objects such as policy name, version, and affected devices. Given a policy, set of policies, or policy checks, that must be enumerated against a given system, system component or system IT asset that also requires the use of this policy-related criteria, i.e. policy context, programming logic is used to cross-reference the defined one or more policy entities against the system configuration, system component configuration and/or system IT asset configuration to validate applicability, non-applicability and compliance or non-compliance of the policy, set of policies, or policy checks. The results of cross-referencing the one or more policy entities against the system configuration, system component configuration and/or system IT asset configuration are then displayed to a user on a visual display device and/or saved to a storage medium.

### Example 12

One or more network rules entities are defined by populating the one or more network rules entities with objects associated with or relevant to “network rules or policies.” Examples of objects associated with or relevant to “network rules or policies” may include: an IP address\subnet\network, VLAN, serial number, hostnames, MAC address, account name, network rules, documentation, or some user-defined object meeting the systems network rules-related criteria such as an approved network rules entity containing network rules objects such as approved network-related access control lists (ACLs), policy maps (a type of access control list (ACL)), routes, services, affected devices, and supporting policies. Given a policy, set of policies, or policy checks, that must be enumerated against a given system, system component or system IT asset that also requires the use of this network rules-related criteria, i.e. network rules context, programming logic is used to cross-reference the defined one or more network rules entities against the system configuration, system component configuration and/or system IT asset configuration to validate applicability, non-applicability and compliance or non-compliance of the policy, set of policies, or policy checks. The results of cross-referencing the one or more network rules entities against the system configuration, system component configuration and/or system IT asset configuration are then displayed to a user on a visual display device and/or saved to a storage medium.

### Example 13

One or more VLAN entities are defined by populating the one or more VLAN entities with objects associated with or relevant to a “VLAN.” Examples of objects associated with or relevant to a “VLAN” may include: an IP address\subnet\network, VLAN, serial number, hostnames, MAC address, account name, VLAN, documentation, or some user-defined object meeting the systems VLAN-related criteria such as an unused ports VLAN entity containing VLAN IDs. Given a policy, set of policies, or policy checks, that must be enumerated against a given system, system component or system IT asset that also requires the use of this VLAN-related criteria, i.e. VLAN context, programming logic is used to cross-reference the defined one or more VLAN entities against the system configuration, system component configuration and/or system IT asset configuration to validate applicability, non-applicability and compliance or non-compliance of the policy, set of policies, or policy checks. The results of cross-referencing the one or more VLAN entities against the system configuration, system component configuration and/or system IT asset configuration are then displayed to a user on a visual display device and/or saved to a storage medium.

### Example 14

One or more checksum entities are defined by populating the one or more checksum entities with objects associated with or relevant to a “checksum.” Examples of objects associated with or relevant to a “checksum” may include: IP address\subnet\network, checksums, serial number, hostnames, MAC address, account name, checksums, documentation, or some user-defined object meeting the systems checksums-related criteria such as a validated OS checksums entity containing an uploaded list of validated operating system checksums. Given a policy, set of policies, or policy checks, that must be enumerated against a given system, system component or system IT asset that also requires the use of this checksums-related criteria, i.e. checksums context, programming logic is used to cross-reference the defined one or more checksums entities against the system configuration, system component configuration and/or system IT asset configuration to validate applicability, non-applicability and compliance or non-compliance of the policy, set of policies, or policy checks. The results of cross-referencing the one or more checksums entities against the system configuration, system component configuration and/or system IT asset configuration are then displayed to a user on a visual display device and/or saved to a storage medium.

### Example 15

One or more BOGON entities are defined by populating the one or more BOGON entities with objects associated with or relevant to a “BOGON.” Examples of objects associated with or relevant to an “BOGON” may include: IP address\subnet\network, serial number, hostnames, MAC address, account name, documentation, or some user-defined object meeting the systems BOGON-related criteria such as a BOGON IP subnets entity containing an uploaded list of unregistered BOGON IP subnets. Given a policy, set of policies, or policy checks, that must be enumerated against a given system, system component or system IT asset that also requires the use of this BOGON-related criteria, i.e. BOGON context, programming logic is used to cross-reference the defined one or more BOGON entities against the system configuration, system component configuration and/or system IT asset configuration to validate applicability, non-applicability and compliance or non-compliance of the policy, set of policies, or policy checks. The results of cross-referencing the one or more BOGON entities against the system configuration, system component configuration and/or system IT asset configuration are then displayed to a user on a visual display device and/or saved to a storage medium.

### Example 16

Given a policy, set of policies, or policy checks, that must be enumerated against a given system, system component or system IT asset that also requires the use of a combination of the internal-related criteria and external-related criteria, i.e. perimeter context, programming logic is used to cross-reference a defined one or more internal entities and a defined one or more external entities against the system configuration, system component configuration and/or system IT asset configuration to validate applicability, non-applicability and compliance or non-compliance of the policy, set of policies, or policy checks. The results of cross-referencing the one or more internal entities and the one or more external entities against the system configuration, system component configuration and/or system IT asset configuration are then displayed to a user on a visual display device and/or saved to a storage medium.

This example exemplifies the use of multiple defined entities to build more complex contextual requirements. The number of entities to be cross-referenced is only limited to the number of required entities to be cross referenced.

### Example 17

Given a policy, set of policies, or policy checks, that must be enumerated against a given system, system component or system IT asset which also requires the use of a combination of premise-related criteria and network rules-related criteria, i.e., premise device approved network rules context, programming logic is used to cross-reference a defined one or more premise entities and a defined one or more network rules entities against the system configuration, system component configuration and/or system IT asset configuration to validate applicability, non-applicability and compliance or non-compliance of the policy, set of policies or policy checks. The results of cross-referencing the one or more premise entities and the one or more network rules entities against the system configuration, system component configuration and/or system IT asset configuration are then displayed to a user on a visual display device and/or saved to a storage medium.

This example exemplifies the use of multiple defined entities to build more complex contextual requirements. The number of entities to be cross-referenced is only limited to the number of required entities to be cross referenced.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

1-30. (canceled)

31. A method comprising the following steps:
(a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration;
(b) producing results for the applicability, non-applicability, compliance and/or non-compliance of a policy, set of policies, and/or policy checks with respect to the system configuration, system component configuration and/or system IT asset configuration based on the cross-referencing of step (a); and
(c) displaying the results of step (b) on a visual display device and/or saving the results of step (b) to a storage medium,
wherein the one or more defined entities comprise one or more defined external entities.

32. The method of claim 31, wherein the method comprises the following step:
(d) defining the one or external more entities by populating the one or more external entities with associated objects for the one or more external entities to thereby produce the one or more defined external entities.

33. The method of claim 31, wherein step (c) comprises displaying the results on a visual display device.

34. The method of claim 31, wherein step (c) comprises saving the results of step (b) to a storage medium.

35. An apparatus comprising:
one more processors, and
one or more machine-readable media for storing instructions thereon which when executed by the one or more processors cause the one or more processors to perform a method comprising the following steps:
(a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration;
(b) producing results for the applicability, non-applicability, compliance and/or non-compliance of a policy, set of policies, and/or policy checks with respect to the system configuration, system component configuration and/or system IT asset configuration based on the cross-referencing of step (a); and
(c) displaying the results of step (b) on a visual display device and/or saving the results of step (b) to a storage medium,
wherein the one or more defined entities comprise one or more defined external entities.

36. The apparatus of claim 35, wherein the method comprises the following step:
(d) defining the one or external more entities by populating the one or more external entities with associated objects for the one or more external entities to thereby produce the one or more defined external entities.

37. The apparatus of claim 35, wherein step (c) comprises displaying the results on a visual display device.

38. The apparatus of claim 35, wherein step (c) comprises saving the results of step (b) to a storage medium.

39. A machine-readable medium having stored thereon sequences of instructions that when executed the one or more processors cause the one or more processors to perform a method comprising the following steps:
(a) cross-referencing one or more defined entities against a system configuration, system component configuration and/or system IT asset configuration to thereby validate applicability, non-applicability, compliance and/or non-compliance of a policy, set of policies, and/or policy checks with respect to the system, system component and/or system IT asset configuration;
(b) producing results for the applicability, non-applicability, compliance and/or non-compliance of a policy, set of policies, and/or policy checks with respect to the system configuration, system component configuration and/or system IT asset configuration based on the cross-referencing of step (a); and
(c) displaying the results of step (b) on a visual display device and/or saving the results of step (b) to a storage medium,
wherein the one or more defined entities comprise one or more defined external entities.

40. The machine-readable medium of claim 39, wherein the method comprises the following step:
(d) defining the one or external more entities by populating the one or more external entities with associated objects for the one or more external entities to thereby produce the one or more defined external entities.

41. The machine-readable medium of claim 39, wherein step (c) comprises displaying the results on a visual display device.

42. The machine-readable medium of claim 39, wherein step (c) comprises saving the results of step (b) to a storage medium.

43-54. (canceled)
